(19) United States
(12) Patent Application Publication
(10) Pub. No.: US 2024/0399608 A1
(43) Pub. Date: Dec. 5, 2024

(54) CHAINSAWS, METHODS OF CONTROLLING CHAINSAWS, AND COMPUTER PROGRAMS IMPLEMENTING SUCH METHODS

(71) Applicant: HUSQVARNA AB, Huskvarna (SE)

(72) Inventors: Martin Larsen, Jonkoping (SE); Jens Elmwall, Motala (SE); Johan Landen, Jonkoping (SE); Anders Hansson, Huskvarna (SE)

(21) Appl. No.: 18/698,070

(22) PCT Filed: Sep. 2, 2022
(86) PCT No.: PCT/SE2022/050786

§ 371 Date: Apr. 3, 2024

(30) Foreign Application Priority Data
Oct. 8, 2021 (SE) 2151238-9

(51) Int. Cl. B27B 17/10; F16D 7/02

(52) U.S. Cl. CPC B27B 17/10; F16D 7/021

(57) ABSTRACT

A handheld battery-powered chainsaw comprises an electric motor (22) and a transmission arrangement (28) coupled to the electric motor (22), wherein the electric motor (22) is configured to drive a saw chain via the transmission arrangement (28). The transmission arrangement (28) comprises a slip clutch (34), comprising a drive member (36) configured to receive rotary power from the electric motor (22) and a driven member (38) configured to transmit rotary power to the saw chain (16), wherein the slip clutch (34) is configured to at least partly disengage the electric motor (22) from the saw chain by enabling a slip in the engagement between the drive member (36) and the driven member (38).

### FIELD OF THE INVENTION

The present invention relates to a handheld battery-powered chainsaw, to methods of controlling such a chainsaw, and to a computer program product and a data carrier storing a computer program product implementing such methods.

### BACKGROUND

Chainsaws have been known for the last 100 years or so. Due to considerations of weight vs power and operation time, most chainsaws are still powered by internal combustion engines of two-stroke type, but battery powered chainsaws are becoming increasingly popular. However, obtaining high output power, high cutting efficiency and high usability without compromising other aspects of the chainsaw, such as weight or battery time, still remains a challenge. Moreover, there is an incessant strive to make chainsaws safer and easier to use.

### SUMMARY

It is an object of the present invention to solve, or at least mitigate, parts or all of the above mentioned problems. To this end, there is provided a handheld battery-powered chainsaw comprising an electric motor and a transmission arrangement coupled to the electric motor, wherein the electric motor is configured to drive a saw chain via the transmission arrangement, wherein the transmission arrangement comprises a slip clutch, comprising a drive member configured to receive rotary power from the electric motor and a driven member configured to transmit rotary power to the saw chain, wherein the slip clutch is configured to at least partly disengage the electric motor from the saw chain by enabling a slip in the engagement between the drive member and the driven member. The slip clutch may be a mechanical clutch, such as a centrifugal clutch, a belt clutch, a selectably engageable idler wheel, an electromechanical/electromagnetic clutch such as an electromagnetically actuated friction-plate clutch, or a fluid coupling. As understood herein, a slip clutch is a clutch which allows, or may be brought to a state in which it allows, the drive and driven members to slip in relation to each other, and thereby transfer a torque via the slipping engagement, wherein the transferred torque is sufficient to drive the saw chain if the saw chain is unloaded. When set in motion, the gradual, slipping engagement of the clutch may enable a progressively increasing power transfer without any drop in the electric motor's rotational speed. This makes it easier to (re-)start the chain when already in engagement with the material to be cut, because the torque will not drop in response to a rotational speed drop to zero. Moreover, an inertia built up by a rotor of the electric motor may contribute to starting the chain. Still further, the slip clutch provides a soft engagement with the chain, which results in an improved general user experience. A slip clutch may also give feedback to the user when the saw chain is overloaded, for example by the user pressing the saw chain too hard against the material to be cut, since it is for many clutch types quite easy to hear when the clutch is slipping. The audible and/or haptic feedback may prompt the user to release the load, and with the high torque from the electric motor at low rotational speeds, the electric motor restarts the chain directly, immediately bringing back the chainsaw to a high cutting efficiency. When slipping, the electric motor is not stopped even if the operator presses the saw chain too hard against the material to be cut. Still further, some electric motor types provide only a low to moderate torque at standstill, whereas already at very low rotational speeds, the torque reaches its maximum. The slip clutch thereby enables a freer selection of the electric motor type. The handheld battery-powered chainsaw may further comprise a finger-operated trigger coupled to an electric switch for selectably operating the electric motor. The trigger may be configured to enable operating the electric motor over a step-wise or continuous range of output powers, rotational speeds, and/or output torques; alternatively, the trigger may be configured for a plain on/off control of the electric motor. According to embodiments, the drive member of the slip clutch may be rotationally fixed to the electric motor. Similarly, the driven member of the slip clutch may be rotationally fixed to a saw chain drive sprocket for driving the saw chain. According to further embodiments, the drive member may be rigidly connected to an output shaft of the electric motor, and/or the driven member may be rigidly connected to a saw chain drive member, such as a saw chain drive sprocket or a keyed shaft configured to mate with a saw chain drive rim. According to embodiments, the chainsaw may comprise a battery compartment configured to receive a battery for powering the chainsaw. Alternatively or additionally, the chainsaw may be configured to be connected to e.g. a backpack battery. A typical suitable DC battery voltage range for providing power to the electric motor may be between 18V and 100V, and more preferably, between about 36V and about 72V. The electric motor may be configured to provide an output power in an exemplary power range of e.g. 1.8 KW-3.5 KW.

According to embodiments, the transmission arrangement may be configured to provide a transmission ratio of 1:1 between the electric motor and a saw chain sprocket meshing with the saw chain. Here, a transmission ratio of 1:1 means that if the drive member is rotationally locked to the driven member in a non-slipping manner, one full turn of the electric motor corresponds to one full turn of the saw chain sprocket. According to embodiments, the saw chain sprocket may be coaxial with an output shaft of the electric motor.

According to embodiments, the slip clutch may be configured to transfer a slip torque, while slipping, of between 2 Nm and 4.5 Nm. Such a torque range has been found to be well suited for a handheld battery-powered chainsaw. According to some embodiments, the slip clutch may be configured to transfer a slip torque, while slipping, of between 2 Nm and 3 Nm.

According to embodiments, the slip clutch may be movable between an engaged state, in which the slip clutch is configured to drive the saw chain, and a disengaged state, in which the drive member can rotate freely without driving the saw chain. This may enable the use of a less costly electric motor. For example, a vector controlled brushless DC motor often comprises rotor position sensors, for sensing the exact rotor position within the motor, to enable starting the electric motor in the intended, forward direction. A disengaged state may enable the rotor position sensors to be dispensed with. Lack of information about the rotor position may result in inadvertently starting the electric motor in the reverse direction. After an initial move in the reverse direction, the vector control will thereafter automatically turn the electric motor to the forward direction. In the disengaged state, such a reversal of directions may pass unnoticed by the operator since it can be done without moving the chain.

According to embodiments, the slip clutch may be configured to transit between the engaged state and the disengaged state in response to a change in rotational speed. When using a handheld chainsaw, the chain shall do the work, but the operator generally applies some force to get the best cutting efficiency possible. If excessive force is applied, the chainsaw will eventually stop due to its limitation in torque. With petrol chainsaws there is an audible cue when the engine is excessively loaded, and the operator can back off the force applied to not stall the engine. However, when excessively loading an electric motor it generally stalls in a more sudden and abrupt manner, and often without any substantial audible, visible or haptic cue. This can be frustrating for the user, who needs to release the pressure on the chainsaw before being able to continue the cut. The stop can also result in squeezing the saw chain, for example when felling a tree. Thereby, and as generally known by skilled chainsaw operators, unplanned stops can even result in potentially dangerous situations. The use of a rotational speed actuated clutch on the electric chainsaw may however prevent sudden and unexpected stalling at high loads, for example when cutting large logs. Moreover, a distinguishable engagement state or engagement speed of the clutch makes it is easier for the user to notice an excessive load situation and back off before the cutting efficiency is affected too much, without the motor stalling completely and suddenly. The character of a typical electric motor, with comparatively high torque on low to midrange rpm, is particularly well suited for restarting the chain during e.g. felling. By way of example, the slip clutch may be an electromechanical clutch, and the chainsaw may comprise a controller configured to engage the electromechanical clutch based on a detected rpm of the electric motor. Alternatively, the slip clutch may be strictly mechanically actuated, for example by the inertia of the transmission. According to embodiments, the slip clutch may be configured to transit between the disengaged and engaged states at a clutch engagement speed, above which the clutch assumes the engaged state. The clutch engagement speed may be predetermined. For example, it may be set as a control value in a controller of the chainsaw, or it may be determined by the mechanical design of a centrifugal clutch. An exemplary suitable engagement speed of the slip clutch may be between 2000 rpm and 7000 rpm, more preferably, between 3000 rpm and 6000 rpm, and even more preferred, between 4500 and 5800 rpm. The slip clutch may be actuated e.g. in response to a change in rotational speed of the motor and/or the drive member.

According to embodiments, the slip clutch may be configured to transit, in response to a change in rotational speed of the drive member, between a slip-enabling state, in which the drive member may slip in relation to the driven member, and a lock-up state, in which the slip clutch is configured to drive the saw chain without slipping. According to embodiments, the slip clutch may be configured to transit from the slip-enabling state to the lock-up state at a predetermined slip limit speed, above which the slip clutch assumes the lock-up state. The slip clutch may be actuated to transit between the slip-enabling state and the lock-up state e.g. in response to a change in rotational speed of the motor and/or the drive member. The slip limit speed is defined as the rotational speed at which the slip torque of the clutch, i.e. torque required to make the drive member slip in relation to the driven member, exceeds the motor torque. Typically, for e.g. a centrifugal clutch, the slip torque of the clutch increases with the rotational speed of the drive member. The slip limit speed will thereby also be the speed assumed by the drive member if the driven member is firmly held in a non-rotating position while operating the chainsaw. Thereby, the slip limit speed is higher than any engagement speed as defined above. An exemplary suitable slip limit speed of the slip clutch may be between 3500 rpm and 7500 rpm, and more preferably, between 5500 and 7000 rpm. According to embodiments, the slip torque, at the slip limit speed, is between 2 Nm and 4.5 Nm. According to embodiments, the slip torque, at the slip limit speed, is between 2 Nm and 4.5 Nm. More preferably, the slip torque at the slip limit speed is between 2 Nm and 3 Nm.

According to embodiments, the slip clutch may be configured to transit between the disengaged and engaged states at a predetermined clutch engagement speed, above which the clutch assumes the engaged state, and to transit from the slip-enabling state to the lock-up state at a predetermined slip limit speed, above which the slip clutch assumes the lock-up state, wherein the slip limit speed is at least 200 rpm higher than the engagement speed. This warrants a smooth transition between the disengaged state and the lock-up state of the slip clutch. An abrupt engagement of the slip clutch may abruptly slow down the rotor of the electric motor, and thereby induce a current peak in the windings of the electric motor. This may cause overheating of the windings, and/or cause voltage peaks or arcing that may damage e.g. drive electronics. By way of example, the stator windings of a brushless DC motor are typically of so-call air-gap winding type, with limited ability to convect heat. According to further embodiments, the slip limit speed is at least 1000 rpm higher than the engagement speed. Preferably, the slip limit speed is less than 2500 rpm higher than the engagement speed.

According to embodiments, the slip clutch may be inertia actuated. Thereby, the slip clutch may be actuated, i.e. transit between the engaged state and the disengaged state, and/or between the slip-enabling and lock-up states, by the inertia of a suitable part of the transmission arrangement. For example, the slip clutch may be embodied as a centrifugal clutch. The slip clutch may also be actuated by a clutch actuation mechanism similar to a Bendix drive.

According to embodiments, the slip clutch may be configured as a centrifugal clutch. The driven member may be configured as a clutch drum, and the drive member may comprise one or more friction shoes which may be configured to, responsive to rotation of the drive member, move radially, optionally against a resilient bias, to engage with a radially inwards-facing face of the clutch drum. The clutch drum may be rotatably mounted in a bearing on the output shaft of the electric motor.

According to embodiments, the driven member may comprise a clutch drum having a diameter of between 60 mm and 90 mm, and the drive member may comprise a set of two or three, preferably two, friction shoes which are resiliently connected to each other by resilient elements, wherein each of the friction shoes has a respective weight of between 30 g and 70 g, and each of the resilient elements 70a, 70b has a spring constant of between 35 N/mm and 60 N/mm. It has been found that torque transfer at the slip limit speed of such a clutch is particularly well adapted to the behaviour of an electric motor in the typical torque range suited for a battery-powered chainsaw. A somewhat more preferred range for the diameter of the clutch drum is between 65 mm and 82 mm. Alternatively or additionally, a somewhat more preferred range for the weight of each of the respective friction shoes is between 40 g and 60 g. Alternatively or additionally, a somewhat more preferred range for the spring constant of each of the resilient elements is between 60 N/mm and 50 N/mm. According to further embodiments, a product of the clutch drum diameter and the total weight of the set of friction shoes lies between 5 000 g*mm and 10 000 g*mm.

According to embodiments, the slip clutch may have a proximal side facing the electric motor and a distal side facing away from the electric motor, wherein a saw chain drive sprocket is connected to the driven member of the slip clutch on the distal side of the slip clutch. Such an arrangement facilitates access to the saw chain drive sprocket, which may in turn facilitate e.g. replacing the saw chain. According to embodiments, the driven member may be a clutch drum. The clutch drum may be open towards the proximal side to enable receiving the drive member via the proximal side.

According to alternative embodiments, the slip clutch may have a proximal side facing the electric motor and a distal side facing away from the electric motor, wherein a saw chain drive sprocket is connected to the driven member of the slip clutch on the proximal side of the slip clutch. Such an arrangement positions the chain drive sprocket closer to the lateral centre of the chainsaw, which may be particularly well suited for compact chainsaws. According to embodiments, the driven member may be a clutch drum. The clutch drum may be open towards the distal side to enable receiving the drive member via the distal side. Moreover, the clutch drum orientation may be conveniently combined with a separate brake drum, for braking the driven side of the transmission arrangement, on the proximal side of the clutch drum and/or on the proximal side of the saw chain drive sprocket.

According to embodiments, the electric motor may have a rotor configured to be rotated by a stator, the rotor having an outer rotor diameter, and an output shaft drivingly connected to the drive member of the slip clutch, the output shaft having a shaft diameter, wherein a ratio between the rotor diameter and the shaft diameter is between 2.5 and 4.8. Such a ratio range has been found suitable to obtain a proper balance between weight and durability of the transmission arrangement. The use of a slip clutch increases the length of the free end of the output shaft, as well as the mass carried by the free end. An engagement face of the driven member may have a clutch engagement face diameter, and an exemplary suitable ratio between the rotor diameter and the clutch engagement face diameter may be between 0.50 and 1.2. A typical suitable shaft diameter may be, e.g., between 10 mm and 15 mm. According to embodiments, a clutch drum as defined hereinabove may be rotatably arranged on the output shaft via a bearing, such as a needle roller bearing. The shaft diameter may be the diameter of the shaft at the axial position of the bearing. Optionally, the output shaft may be provided with a lubrication channel extending from the needle bearing to a lubricant inlet in an end face of the output shaft.

According to embodiments, the slip clutch may be electromagnetically actuated based on a clutch control signal. For example, the slip clutch may be actuated by energizing a coil which axially, i.e. along the rotation axis of the slip clutch, moves at least one of the drive member and the driven member into engagement with the other of the drive member and the driven member. Optionally, the chainsaw may comprise a sensor configured to detect an engagement status of the slip clutch, i.e. whether the slip clutch is in an engaged state or in a disengaged state, and/or whether the slip clutch is in a slip-enabling state or in a lock-up state. Thereby, the status may be communicated to the chainsaw operator. According to embodiments, the chain saw may further comprise a controller configured to determine a rotational speed of the electric motor, and to control, based on the rotational speed, the engagement of the slip clutch. Such an arrangement may enable, for example, added freedom in the selection or adjustment of a clutch engagement speed. According to some embodiments, the chainsaw may be provided with a user interface enabling a user to set the clutch engagement speed.

According to embodiments, the handheld battery-powered chainsaw may further comprise a mechanical brake arrangement movable between a braking position, in which the mechanical brake arrangement is configured to engage with the transmission arrangement to brake the rotation of the driven member, and a released position, in which the driven member is free to rotate. According to embodiments, the mechanical brake arrangement is configured to engage with the transmission arrangement on the driven member side of the slip clutch. Thereby, the mechanical brake arrangement may stop the saw chain from rotating regardless of the engagement position of the slip clutch. Alternatively or additionally, according to embodiments, the mechanical brake may comprise a brake drum and a brake band configured to be tightened about the brake drum. The brake drum may be separate from any clutch drum, as the case may be; alternatively, a brake band may be provided to engage with a radially outer face of a centrifugal clutch drum, which may thereby double as a brake drum.

According to embodiments, the handheld battery-powered chainsaw may further comprise a rear handle provided with a finger-operated trigger for operating the electric motor, wherein the mechanical brake arrangement is configured to operate independent of the position of the trigger. Thereby, safe operation in all situations can be obtained. According to embodiments, the mechanical brake arrangement may be configured to remain in the released position when releasing the trigger. Thereby, inertia of the motor and transmission may be at least partly maintained when releasing the trigger, which may reduce power consumption. This may of course be of particular benefit on a battery-powered chainsaw.

According to embodiments, the driven member may comprise a clutch drum, and the mechanical brake arrangement may comprise a brake band configured to, responsive to actuation of a brake actuator, apply a clamping force on a radially outer face of said clutch drum. The brake actuator may comprise a kick-back brake lever configured as a hand guard in front of a handle of the chainsaw.

According to embodiments, the mechanical brake arrangement may comprise a brake drum axially separated from the slip clutch, and a brake band configured to, responsive to actuation of a brake actuator, apply a clamping force on a radially outer face of said brake drum. According to further embodiments, the brake drum may be positioned on the proximal side of the clutch, which results in a particularly compact arrangement. Again, the brake actuator may comprise a kick-back brake lever configured as a hand guard in front of a handle of the chainsaw.

According to embodiments, the handheld battery-powered chainsaw may further comprise an electrically controlled brake, such as an electromagnetic brake and/or an induction brake. Such a brake may contribute to stopping the saw chain. The electrically controlled brake may be selectively actuated by a controller, e.g. in response to detecting that a trigger for operating the electric motor is released by the operator. For example, an induction brake may be implemented in a motor controller to selectively apply a braking force to the motor rotor. According to an alternative example of an induction brake, the chainsaw may be configured to short the electric motor windings when the trigger is released by the operator.

According to embodiments, the electrically controlled brake may be configured to apply a braking force to the drive member side of the slip clutch, i.e. to the motor, to the drive member, and/or to any element fixedly attached thereto. Such an electrically controlled brake may provide a particularly compact and lightweight arrangement. It may beneficially be combined with a mechanical brake for braking the driven member side of the slip clutch.

According to embodiments, the chainsaw may be configured to release said electrically controlled brake in response to a rotational speed of the electric motor falling below an electric brake release speed. Thereby, angular momentum of the motor and drive member may be at least partly maintained when releasing the trigger, which saves electrical energy and, the next time the trigger is pressed, shortens the time to accelerate the motor to the clutch engagement speed. Moreover, if combined with a fan, cooling of the motor and/or any battery and/or controller is improved. Preferably, if combined with a slip clutch which is actuated in response to a change in rotational speed of the drive member as defined hereinabove, the electric brake release speed is more than half the clutch engagement speed, and even more preferred, at least 80% of the clutch engagement speed.

According to embodiments, the electric motor may comprise a rotor configured to rotate about a motor rotation axis, and the drive member is rotationally locked in a rotationally form-fitting manner to the rotor to prevent rotation of the drive member in both rotation directions about the motor rotation axis. By way of example, the drive member may be keyed to an output shaft of the electric motor, for example via splines, a woodruff key, or a D-shaped keyed engagement. According further to embodiments, the drive member may be axially held to the output shaft by means of e.g. a nut or a screw, optionally in combination with a washer. A form-fitting rotational lock may be particularly beneficial when combined with electric braking of the motor, since either braking or accelerating may otherwise bring the drive member in rotation in relation to the rotor, even if there is a strong friction engagement between them.

According to embodiments, the handheld battery-powered chainsaw may further comprise a cooling fan coupled to always run with the drive member side of the slip clutch. Thereby, it is possible to operate the cooling fan without operating the saw chain. This makes it possible to cool any parts of the chainsaw that may benefit from cooling, such as the motor, the controller and/or the battery, at any time. For example, it is possible to operate the cooling fan to cool the chainsaw before using it in high ambient temperatures, or when the chainsaw has been stored in a warm environment. Moreover, as a chainsaw is in a typical use case run at maximum power in an intermittent manner, the cooling fan may cool the chainsaw during the intermissions. This enables designing the chainsaw with a higher peak output power without increasing the risk of overheating any part thereof, or without triggering any overheating protection mechanism, as the case may be. The cooling fan may be arranged in a housing shaped to direct a flow of air to the motor, the controller and/or the battery. According to further embodiments, the cooling fan may be rigidly connected to the output shaft of the motor. The cooling fan may comprise a fan rotor provided with a set of vanes configured to set the cooling air in motion. According to some embodiments, the cooling fan may be configured as an axial-flow fan. According to other embodiments, the cooling fan may be configured as a centrifugal fan comprising an impeller arranged in a volute. The latter has the additional benefits that it is well suited for obtaining relatively higher cooling air pressures, which may be beneficial for pressing the cooling air to all relevant areas when the components are densely packed in a compact configuration. The fan may be made of e.g. aluminium or plastic.

According to embodiments, the slip clutch may be positioned on a first axial side of electric motor, and the cooling fan may be positioned on a second axial side of the motor, opposite to said first axial side. Such an arrangement enables positioning the electric motor towards the lateral centre of the chainsaw, which warrants a good balance and increased comfort of the chainsaw. According to embodiments, the electric motor may be arranged in a motor housing, and the cooling fan may comprise a fan rotor provided with a plurality of vanes, wherein the cooling fan has an outer diameter exceeding a diameter of the motor housing. Thereby, cooling of the slip clutch may be improved.

According to embodiments, the handheld battery-powered chainsaw may further comprise a saw chain oil pump coupled to receive power from the driven member side of the slip clutch. Thereby, saw chain oil will be supplied to the saw chain only when the saw chain is moving, even if the electric motor is running. This saves saw chain oil. According to further embodiments, the oil pump may be operated by the driven member side of the slip clutch via a worm drive. The worm screw of the worm drive may be coaxial with the rotation axis of the electric motor. According to embodiments, the worm screw may be positioned between the electric motor and the slip clutch.

According to embodiments, the handheld battery-powered chainsaw may further comprise a controller configured to operate the slip clutch between an engaged state, in which the slip clutch is configured to drive the saw chain, and a disengaged state, in which the drive member can rotate freely without driving the saw chain. For example, the controller may operate the slip clutch in response to operator input by operating the rotational speed of the electric motor above or below a clutch engagement speed.

According to embodiments, the controller may be configured to maintain operation of the electric motor with the slip clutch disengaged. Thereby, any auxiliary components, such as a fan, connected to the motor or transmission arrangement on the drive side of the slip clutch, may be operated without operating the saw chain. In particular, the controller may be configured to maintain operation of the electric motor with the slip clutch disengaged in response to detecting that a finger-operated trigger for operating the electric motor is fully released. For example, the slip clutch may be a centrifugal clutch and the electric motor may be maintained at an idle speed below the engagement speed of the centrifugal clutch. The idle speed may be a predetermined speed set in the controller. An exemplary suitable idle speed may be between 2000 rpm and 6000 rpm, and more preferably, between 3000 rpm and 5500 rpm. According to embodiments, the controller may be configured to maintain operation of the electric motor for a predetermined time, which predetermined time may typically be greater than two seconds, and more typically greater than ten seconds, without engaging the slip clutch. Alternatively or additionally, the controller may be configured to maintain operation of the electric motor until an external event is detected, for example that the temperature of a certain part of the chainsaw falls below a limit temperature, or that a power switch of the chainsaw is switched off. According to embodiments, the controller may be configured to automatically start operation of the electric motor without engaging the slip clutch when the chainsaw is e.g. switched on via an on/off switch, or when the chainsaw detects that it has been lifted or gripped by a handle.

According to embodiments, the controller may be configured to maintain operation of the electric motor with the slip clutch disengaged, thereby operating a cooling fan of the chainsaw, based on a condition that a detected temperature exceeds a limit temperature. According to further embodiments, the chainsaw may further comprise at least one temperature sensor, and the detected temperature may be a temperature detected by said at least one temperature sensor. By way of example, the at least one temperature sensor may detect the temperature of the motor, the controller, and/or the battery. Alternatively, the detected temperature may be an ambient temperature detected by a temperature sensor external to the chainsaw. The limit temperature may be fixed, or may be dynamically set.

According to embodiments, the handheld battery-powered chainsaw may further comprise a trigger movable between a depressed position, responsive to which the electric motor is operated to move the saw chain, and a released position, responsive to which the saw chain is stopped, wherein the controller is configured to enable operation of the electric motor when the trigger is in the released position.

According to embodiments, the controller may be configured to enable operation of the electric motor when the trigger is in the released position based on a condition that a mechanical brake, configured to brake the driven member, is engaged. Such an arrangement increases the safety of the chainsaw by mitigating the consequences of any malfunction of the slip clutch.

According to embodiments, the controller may be configured to detect excessive clutch slip, for example by detecting extended operation below a slip limit speed above which the slip clutch assumes a lock-up state; and in response to detecting excessive clutch slip, apply a change in a control signal for operating the electric motor. Excessive clutch slip, i.e. clutch slip which excessively extends over time, is an undesirable condition which generates heat and causes wear of the slip clutch and the electric motor. For example, the controller may be configured to determine that slip has occurred during a time which exceeds a predetermined slip limit time. Exemplary suitable changes in the control signal for operating the electric motor may be to automatically increase the torque, which may e.g. increase the rotational speed of the slip clutch above a slip limit speed and thereby set the saw chain in motion, or to automatically reduce the rotational speed of the motor towards or below a clutch engagement speed in order to reduce wear and heat generation. Moreover, the change in the control of the electric motor may also contribute to audibly or haptically alerting the chainsaw operator of the excessive slip, such that the chainsaw operator may take corrective action by e.g. decreasing the applied saw chain pressure onto the material to be cut, or by releasing a trigger as defined hereinabove.

According to embodiments, applying said change in a control signal for operating the electric motor may comprise pulsing the torque delivered by the electric motor, and/or varying the rotational speed of the electric motor. Thereby, the user may be efficiently notified, audibly or haptically, in a highly intuitive manner, that the electric motor struggles to exceed the slip torque of the slip clutch, and may take corrective action by e.g. decreasing the applied saw chain pressure onto the material to be cut. Moreover, a pulsed torque or varying speed may facilitate to set a saw chain, which may have become stuck, back in motion. The torque may be pulsed e.g. by pulsing a drive current to the electric motor, or by applying an intermittent phase shift of a drive current to the electric motor. According to some embodiments, the controller may be configured to pulse the torque at a pulse frequency of more than 20 Hz, and preferably more than 50 Hz, to provide an audible signal. According to other embodiments, the controller may be configured to pulse the torque at a pulse frequency of between 0.2 Hz and 10 Hz, and even more preferably, between 0.5 Hz and 5 Hz, to provide a haptic feedback to the operator. The pulse frequency may be fixed or varied within the pulse train. The pulses may be configured as square-wave pulses, such that audible overtones are emitted in a broad frequency range, thereby enabling hearing the pulses also in complex background noise environments. Similarly, an exemplary suitable speed variation may be periodic with a frequency of e.g. between 0.2 Hz and 10 Hz. An exemplary suitable amplitude of the rotational speed variation may be at least 10 rpm, and more typically, between 50 rpm and 1000 rpm.

According to embodiments, the controller may be configured to pulse the torque delivered by the electric motor for no more than a limit time or a limit number of pulses, and thereafter lower the rotational speed of the electric motor below a clutch engagement speed. Thereby, the chainsaw may be allowed to cool down while further attempts to surpass the slip limit speed are prevented. This enables permitting a higher output power of the electric motor without increasing the risk of overheating or damage to any components. The limit time or limit number of pulses, as the case may be, may be predetermined. According to embodiments, the controller may be configured to pulse the torque for less than 30 seconds, and more preferably, for less than 10 seconds, before lowering the rotational speed of the electric motor below the clutch engagement speed.

According to embodiments, the handheld battery-powered chainsaw may comprise a trigger movable between a depressed position, responsive to which the electric motor is operated to move the saw chain, and a released position, responsive to which the saw chain is stopped, wherein the controller is configured to, after having lowered the rotational speed of the electric motor below the clutch engagement speed, disable any speed increase to the slip limit speed until the trigger has been released, and thereafter pressed again. Such a configuration enables the operator to easily restart the chain using the trigger only.

According to embodiments, the electric motor may be an outrunner comprising a rotationally fixed stator provided with stator windings, radially encircled by a rotor provided with a set of permanent magnets. An outrunner typically cools itself better than an inrunner, which reduces the need for providing a separate fan impeller. Moreover, an outrunner is generally cheaper than an inrunner but has higher rotational inertia, which makes acceleration slower. High rotational inertia is a drawback when accelerating from start, but may be a benefit at higher rotational speeds when the saw chain engages the material to be cut. The combination with a clutch makes it possible to accelerate an outrunner quickly when the clutch is disengaged, thereby providing the benefit of increased rotational inertia at higher speeds, without the drawback of excessively slow acceleration at lower speeds.

According to embodiments, the electric motor may be a vector controlled permanent magnet motor. Such a motor provides a good controllability well suited for the specific operation methods defined herein.

According to embodiments, the controller may be configured to detect an overload of the electric motor, and in response thereto, maintain or increase the torque of the electric motor. Motor overload may be detected by detecting that the rotational speed of the electric motor falls below an expected rotational speed for a certain position of the trigger, or for a certain motor torque. Without a slip clutch, if motor overload is detected, for example by detecting that the rotational speed falls below a limit speed, it may be beneficial to quickly and substantially reduce the electric motor torque, for example by reducing the current supplied to the motor, in order to prevent overheating the motor. However, when combined with a slip clutch, it may be beneficial to maintain a high motor torque also when overload is detected, because the slip clutch will anyhow keep the motor from stopping completely. A maintained or increased torque in the rpm region of a slip limit speed facilitates restarting a saw chain which has become stuck due to e.g. lateral squeeze or excessive pressure applied by the operator. Moreover, if combined with a fan rotated by the motor, the fan will maintain a flow of cooling air to the motor, which improves the preconditions for maintaining a high torque.

According to embodiments, the handheld battery-powered chainsaw may comprise a chainsaw body; an elongate guide bar for guiding the saw chain, wherein a direction of elongation of the guide bar defines a longitudinal axis, the guide bar extending from a front end of the chainsaw body in a forward direction along the longitudinal axis, wherein the guide bar extends in a guide bar plane; a front handle; and a rear handle, wherein a bottom face of the rear handle is provided with a trigger enabling the operator to operate the electric motor, a plane parallel to the guide bar plane and comprising a rearmost point of the trigger intersects a top point of the front handle at an intersection point, and the distance between the intersection point and the rearmost point of the trigger exceeds 270 mm. Thanks to the slip clutch, a large distance between the front handle and the rear handle may be provided without generating substantial problems caused by the operator pressing the chain too hard against the material to be cut. Thereby, the stability and controllability of the chainsaw may be increased. According to further embodiments, the distance between the intersection point and the rearmost point of the trigger may exceed 300 mm, 320 mm, 340 mm, or even 360 mm.

According to embodiments, the chainsaw may be configured to operate the electric motor up to a maximum output power, wherein a ratio between the distance from the intersection point to the rearmost point of the trigger and the maximum output power exceeds 0.11 mm/W. The clutch enables combining a comparatively long distance between the rear and front handles with a moderately powered electric motor without risking stalling the electric motor.

According to embodiments, the chainsaw may be configured to operate the electric motor to generate a motor torque, wherein the motor torque reaches a slip torque at the slip limit speed as defined hereinabove, wherein a ratio between the distance from the intersection point to the rearmost point of the trigger and the slip torque exceeds 90 mm/Nm. The clutch enables combining a comparatively long distance between the rear and front handles with a moderate torque of the electric motor without risking stalling the electric motor.

According to a second aspect, parts or all of the above mentioned problems are solved, or at least mitigated, by a handheld battery-powered chainsaw comprising an electric motor; a transmission arrangement coupled to the electric motor, wherein the electric motor is configured to drive a saw chain via the transmission arrangement; a controller for operating the electric motor; and a trigger operably coupled to the controller, the trigger being movable between a depressed position, responsive to which the controller is configured to operate the electric motor to drive the saw chain, and a released position, responsive to which the controller is configured to stop the driving of the saw chain, wherein the transmission arrangement comprises a clutch, comprising a drive member configured to receive rotary power from the electric motor and a driven member configured to transmit rotary power to the saw chain, wherein the clutch is movable between an engaged state, in which the clutch engages the motor with the saw chain, and a disengaged state, in which the clutch disengages the motor from the saw chain such that the drive member can rotate freely without driving the saw chain, wherein the controller is configured to automatically maintain operation of the electric motor in an idle mode in which the clutch in the disengaged state when the trigger is in the released position. The idle mode maintains rotational inertia of the motor and drive side of the clutch, which enables a faster revving up of the saw chain once the saw chain is to be set in motion. The clutch, which may be e.g. a slip clutch or a dog clutch, may be configured in accordance with any of the embodiments defined hereinbelow or hereinabove. According to embodiments, the clutch may be configured to transit between the engaged and disengaged states based on a rotational speed of the electric motor, and the idle mode may be maintained by operating the electric motor at an idle speed below a clutch engagement speed. The chainsaw according to the second aspect may be combined with the various embodiments of the chainsaw according to the first aspect as defined hereinabove.

According to embodiments, the clutch may be a centrifugal clutch, and the controller may be configured to automatically maintain operation of the electric motor in the idle mode at an idle speed below an engagement speed of the centrifugal clutch. According to further embodiments, the controller may be configured to automatically maintain operation of the electric motor in the idle mode at an idle speed of more than 200 rpm below the engagement speed of the centrifugal clutch, and more preferably, at an idle speed of more than 500 rpm below the engagement speed of the centrifugal clutch. Alternatively or additionally, the controller may be configured to automatically maintain operation of the electric motor in the idle mode at an idle speed of less than 3000 rpm below the engagement speed of the centrifugal clutch, and more preferably, at an idle speed of less than 1500 rpm below the engagement speed of the centrifugal clutch. This is particularly useful in combination with a fan which is operated in idle mode.

According to embodiments, the controller may be configured to automatically maintain operation of the electric motor in the idle mode at an idle speed of between 2000 rpm and 6000 rpm, and more preferably, between 3000 rpm and 5500 rpm.

According to embodiments, the handheld battery-powered chainsaw may further comprise a cooling fan coupled to always run with the drive member side of the clutch.

According to a third aspect, parts or all of the above mentioned problems are solved, or at least mitigated, by a handheld battery-powered chainsaw comprising an electric motor; a transmission arrangement coupled to the electric motor, wherein the electric motor is configured to drive a saw chain via the transmission arrangement; and a flywheel configured to receive and store angular momentum from the electric motor, the flywheel being coupled to rotate with at least a portion of the transmission arrangement about a flywheel rotation axis. When using a chainsaw to cut up logs, especially for firewood, the user typically gives full throttle before starting the cut. Thereby, the added rotational inertia of a flywheel is a great improvement. For example, the typical dip in chain speed when contacting the wood is reduced, and it becomes easier to do a complete cut through. Moreover, for arborists, a quick cut through e.g. branches to be pruned is highly desirable, because this reduces the tendency of the branches to swing down before they're completely cut through. The results from tests that have been performed shows that the added rotational inertia of a flywheel increases the cutting speed when pruning. According to embodiments, the flywheel may be carried by, and optionally be rigidly connected to, an output shaft of the drive motor. According to embodiments, the flywheel may have a weight of between 80 g and 250 g. It may typically have an outer diameter of between 70 mm and 130 mm. An exemplary suitable moment of inertia range of the flywheel may be between 1.2*10⁻⁴ kgm² and 3.5*10⁻⁴ kgm². Alternatively or additionally, at least 80%, and more preferred, at least 85%, of a total weight of the flywheel may be located at a radial position, with respect to the flywheel rotation axis, exceeding 50% of a total radius of the flywheel. Such a weight distribution provides a beneficial ratio between deadweight and rotational inertia. The chainsaw according to the third aspect may be combined with the various embodiments of the chainsaws according to the first and second aspects as defined hereinabove. For example, the chainsaw may comprise a clutch as defined in accordance with any of the embodiments hereinabove. According to further embodiments, the clutch may be positioned on first axial side of electric motor, and the flywheel may be positioned on a second axial side of the motor, opposite to said first axial side. The flywheel may optionally be provided with vanes to operate as a fan. A majority of the weight of the flywheel may be provided by an inertia ring of metal, for example steel. The inertia ring may extend radially to at least 90% of a total radius of the flywheel.

According to a fourth aspect, parts or all of the above mentioned problems are solved, or at least mitigated, by a handheld battery-powered chainsaw comprising an electric motor comprising a rotor configured to be rotated about a motor rotation axis; and a plurality of components configured to be rotated by the electric motor about the motor rotation axis, wherein a total moment of inertia of the rotor and said plurality of components exceeds 1.5*10⁻⁴ kgm². According to further embodiments, the total moment of inertia of said plurality of components may exceed 1.9*10⁻⁴ kgm², and according to even further embodiments, the total moment of inertia of said plurality of components may exceed 2.3*10⁻⁴ kgm², may exceed 2.8*10⁻⁴ kgm², or may even exceed 3.5*10⁻⁴ kgm². The plurality of components may comprise all or a subset of the components of a transmission arrangement, a flywheel, and a fan as defined hereinabove.

According to a fifth aspect, parts or all of the above mentioned problems are solved, or at least mitigated, by a handheld battery-powered chainsaw comprising an electric motor comprising a rotor configured to be rotated about a motor rotation axis; and a plurality of components configured to be rotated by the electric motor about the motor rotation axis, wherein a ratio J/M between a total moment of inertia J of the rotor and all components configured to be rotated by the electric motor about the motor rotation axis, and a total mass M of the rotor and all components configured to be rotated by the electric motor about the motor rotation axis, exceeds 3.6 m². According to further embodiments, said ratio may exceed 4.1 m², may exceed 4.6 m², may exceed 5.1 m², may exceed 5.6 m², or may even exceed 6.1 m². Again, the total moment of inertia of the rotor and all components configured to be rotated by the electric motor about the motor rotation axis may exceed either 1.5*10⁻⁴ kgm², 1.9*10⁻⁴ kgm², 2.3*10⁻⁴ kgm², 2.8*10⁻⁴ kgm², or 3.5*10⁻⁴ kgm², as defined hereinabove.

According to a sixth aspect, parts or all of the above mentioned problems are solved, or at least mitigated, by a method of controlling an electric motor to selectively drive a saw chain in a chainsaw comprising a trigger for initiating a rotation of the saw chain, the method comprising: prior to detecting a depression of the trigger, operating the electric motor; and in response to detecting a depression of the trigger, setting the saw chain in motion. Thereby, inertia of the motor and any transmission arrangement will contribute to the acceleration of the saw chain, which may generate a quicker response of the chainsaw to the operation of the trigger. Depression of the trigger may be detected in relation to a fully released position. The method may be combined with any of the chainsaws defined hereinabove. According to an embodiment, the saw chain may be set in motion by engaging the electric motor with the saw chain via a clutch. Alternatively, the electric motor may be connected to the saw chain via a torque limiter, and the saw chain may be set in motion by releasing a mechanical chain brake. The method may further comprise: prior to detecting said depression of the trigger, driving a cooling fan using said electric motor.

According to embodiments, mechanically engaging the electric motor with the saw chain may comprise increasing a rotational speed of the electric motor above a clutch engagement speed.

According to a seventh aspect, parts or all of the above mentioned problems are solved, or at least mitigated, by a method of controlling an electric motor to selectively drive a saw chain in a chainsaw comprising a trigger for initiating a rotation of the saw chain, the method comprising: in response to detecting a depression of the trigger, operating the saw chain; in response to detecting a release of the trigger, stopping operation of the saw chain; and after stopping operation of the saw chain, maintaining operation of the electric motor. Thereby, inertia may be stored/maintained until the next time the saw chain is to be operated, which saves energy. Alternatively or additionally, the electric motor may maintain operation of other functions, such as the operation of a fan. Operation of the motor may be maintained without setting the saw chain in motion again, at least not until the next time the trigger is depressed. Stopping operation of the saw chain may comprise mechanically disengaging the electric motor from the saw chain. Alternatively, the electric motor may be connected to the saw chain via a torque limiter, and operation of the saw chain may be stopped by engaging a chain brake. The method may further comprise: After detecting said release of the trigger, driving a cooling fan using said electric motor. Optionally, the method may comprise: after detecting a full release of the trigger, operating the electric motor. The method may be combined with any of the methods or chainsaws defined hereinabove.

According to embodiments, mechanically disengaging the electric motor from the saw chain may comprise decreasing a rotational speed of the electric motor below a clutch engagement speed.

According to an eighth aspect, parts or all of the above mentioned problems are solved, or at least mitigated, by a method of controlling an electric motor to selectively drive a saw chain in a chainsaw, the method comprising: in response to detecting a depression of a trigger, operating the electric motor at a first rotational speed; and in response to detecting a release of the trigger, operating the electric motor at a second rotational speed. The method may be combined with any of the methods or chainsaws defined hereinabove, and may, for example, be implemented in a controller of the chainsaw. Preferably, the saw chain is coupled to be operated by the motor at said first rotational speed, and decoupled from operation by the motor at said second rotational speed. According to embodiments, the chainsaw may comprise a fan which is coupled to be rotated by the electric motor when operated at the second rotational speed. Alternatively or additionally, the chainsaw may comprise a saw chain oil pump which is coupled to be operated by the electric motor at said first rotational speed, and decoupled from operation by the motor at said second rotational speed. According to embodiments, the second rotational speed may be lower than a clutch engagement speed.

According to a ninth aspect, parts or all of the above mentioned problems are solved, or at least mitigated, by a method of controlling an electric motor to selectively drive a saw chain in a chainsaw comprising a clutch, the method comprising: determining a state of the clutch; and based on the determined clutch state, adjusting a torque or rotational speed of the electric motor, and/or generating an alert to an operator of the chainsaw. The method may be combined with any of the methods or chainsaws defined hereinabove. Exemplary clutch states may be a disengaged state, a slip-enabled state, a slip state indicating actual slipping of the clutch, and/or a lock-up state. The method may comprise determining whether a single one of the exemplary conditions has occurred, is likely to have occurred, or is likely about to occur. For example, the method may comprise determining that the clutch has been in a slip state for a period of time exceeding a limit time, which limit time may be predetermined or dynamically set. The alert to the operator may be generated by e.g. lighting a lamp, sounding an alarm, or operating the electric motor according to a predetermined pattern. According to embodiments, the determination of a state may comprise determining a rotational speed of the electric motor. For a rotational speed-actuated clutch, the clutch state can be derived directly from the rotational speed.

According to embodiments, determining a state of the clutch may comprise determining a present rotational speed. For example, the torque or rotational speed may be adjusted in response to having determined that the chainsaw has been operated at a slip limit speed as defined hereinabove, or at a slip-enabling speed between a clutch engagement speed and a slip limit speed, for a time exceeding a limit time. Alternatively, the torque or rotational speed may be adjusted in immediate response to having determined operation in a slip state. The torque may be adjusted by controlling an electric current supplied to said motor.

According to embodiments, said clutch state may be a slip state, and adjusting a torque or rotational speed of the electric motor may comprise lowering the rotational speed below the clutch engagement speed, and/or reducing the torque of the electric motor. The torque or rotational speed reduction may be obtained by overriding any operator input from e.g. a trigger. Thereby, extended or excessively hard operation of the chainsaw at the clutch engagement speed may be avoided, which reduces heat generation and increases the lifetime of the clutch and any bearings.

According to embodiments, said clutch state may be a slip state, wherein adjusting a torque or rotational speed of the electric motor comprises increasing the torque of the electric motor. The torque may be temporarily increased above a continuous-operation torque without risking overheating the electric motor. This facilitates setting a stalled chain in motion, for example if the saw chain is pressed hard against the material to be cut or squeezed in a kerf. According to some embodiments, the speed and/or torque may first be lowered, and thereafter raised, or vice versa.

According to a tenth aspect, parts or all of the above mentioned problems are solved, or at least mitigated, by a method of controlling an electric motor to selectively drive a saw chain in a chainsaw, comprising: determining a present rotational speed; based on said determination, actuating an electromechanical clutch, for example an electromagnetic clutch. The electromechanical clutch may be engaged when the speed of the electric motor exceeds a clutch engagement speed. Similarly, the electromechanical clutch may be disengaged when the speed of the electric motor falls below a clutch disengagement speed. The engagement speed may be identical to the disengagement speed. Alternatively, they may be different. Again, the method may be combined with methods or chainsaws defined hereinabove.

According to embodiments, the method may further comprise receiving, from a user interface, a clutch engagement speed setting and/or a clutch disengagement speed setting. Thereby, an operator or service technician may set desired engagement or disengagement speeds to suit different applications. For example, a high clutch engagement speed may be desirable in applications where the saw chain runs a high risk of the saw chain getting jammed, thereby benefitting from a high angular momentum of the motor to set the jammed chain in motion.

According to an eleventh aspect, parts or all of the above mentioned problems are solved, or at least mitigated, by data processing equipment comprising at least one processor and memory, configured to carry out any of the methods as defined hereinabove. The data processing equipment may be arranged in a handheld chainsaw, for example a handheld chainsaw as defined hereinabove. The data processing equipment may be embodied as a microcontroller.

According to a twelfth aspect, parts or all of the above mentioned problems are solved, or at least mitigated, by a computer program product comprising instructions which, when the program is executed on a processor, carries out any of the methods as defined hereinabove.

According to a thirteenth aspect, parts or all of the above mentioned problems are solved, or at least mitigated, by a computer-readable storage medium having stored thereon the computer program product defined above.

It is noted that embodiments of the invention may be embodied by all possible combinations of features recited in the claims. Further, it will be appreciated that the various embodiments described for the devices are combinable with the methods, and vice versa.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1A is a plan view of a handheld battery-powered chainsaw according to a first embodiment as seen from the side;

FIG. 1B is a plan view of the chainsaw of FIG. 1A as seen from above;

FIG. 2 is a perspective view of the chainsaw of FIGS. 1A and 1B with a chain sprocket cover removed to expose a transmission arrangement;

FIG. 3A is a perspective view of an electric motor of the chainsaw of FIG. 2 connected to a fan and the transmission arrangement of FIG. 2;

FIG. 3B is a plan view corresponding to the view of FIG. 3A;

FIG. 4 is a magnified view of an interface between a saw chain, a saw chain drive sprocket, and a guide bar of the chainsaw of FIG. 1A, the view substantially corresponding to a section taken along the line IV-IV of FIG. 3B;

FIG. 5 is a schematic block diagram, illustrating the functional blocks of an electric motor and a controller of the chainsaw of FIG. 1A;

FIG. 6A is an exploded view in perspective of the electric motor, fan, and transmission arrangement of FIGS. 3A and 3B;

FIG. 6B is an exploded view in section of the electric motor, fan and transmission arrangement of FIGS. 3A and 3B, wherein the section is taken along the line VI-VI of FIG. 4B;

FIG. 7A is a view of the electric motor, fan, and transmission arrangement of FIGS. 6A and 6B as seen in a first perspective;

FIG. 7B is a view of the electric motor, fan, and transmission arrangement of FIG. 7A as seen in a second perspective;

FIG. 7C is a plan view of the electric motor, fan, and transmission arrangement of FIGS. 7A and 7B as seen along an axis A indicated in FIG. 7A;

FIG. 7D is a section of the electric motor, fan, and transmission arrangement of FIGS. 7A-C, the section taken along the line D-D of FIG. 7C;

FIG. 8A is a first diagram schematically illustrating torques and rotational speeds of the electric motor and transmission arrangement of FIG. 3A as a function of the rotational speed of the electric motor in a scenario when the saw chain of FIG. 4 is unblocked;

FIG. 8A is a diagram schematically illustrating torques and rotational speeds of the electric motor and transmission arrangement of FIG. 3A as a function of the rotational speed of the electric motor in a scenario when the saw chain of FIG. 4 is blocked;

FIG. 9 is a perspective view of a chainsaw according to a second embodiment, with a chain sprocket cover removed to expose a transmission arrangement according to a second embodiment;

FIG. 10 is a plan view, corresponding to the view of FIG. 3A, of an electric motor of the chainsaw of FIG. 9 connected to a fan and the transmission arrangement of FIG. 9;

FIG. 11 is a perspective view of the transmission arrangement of FIG. 10;

FIG. 12 is a schematic view in section of an electric motor and a transmission arrangement according to a third embodiment;

FIG. 13 is a schematic illustration of a transmission arrangement according to a fourth embodiment;

FIG. 14 is a schematic illustration of a transmission arrangement according to a fifth embodiment;

FIG. 15 is a flow chart illustrating a first method of operating the chainsaws of FIG. 1A and FIG. 9;

FIG. 16 is a flow chart illustrating a second method of operating the chainsaws of FIG. 1A and FIG. 9;

FIG. 17 is a plan view, corresponding to the view of FIG. 3A, of an electric motor driving the transmission arrangement according to the first embodiment, the fan, and a flywheel according to a first embodiment;

FIG. 18A is a plan view, corresponding to the view of FIG. 3A, of the electric motor and transmission arrangement according to the first embodiment, and a combined fan and flywheel;

FIG. 18B is a plan view, as seen along the axis A of FIG. 18A, of the combined fan and flywheel of FIG. 18A; and

FIG. 19 is a perspective view of a data carrier.

All the figures are schematic, not necessarily to scale, and generally only show parts which are necessary in order to elucidate the embodiments, wherein other parts may be omitted.

### DETAILED DESCRIPTION OF THE EXEMPLARY EMBODIMENTS

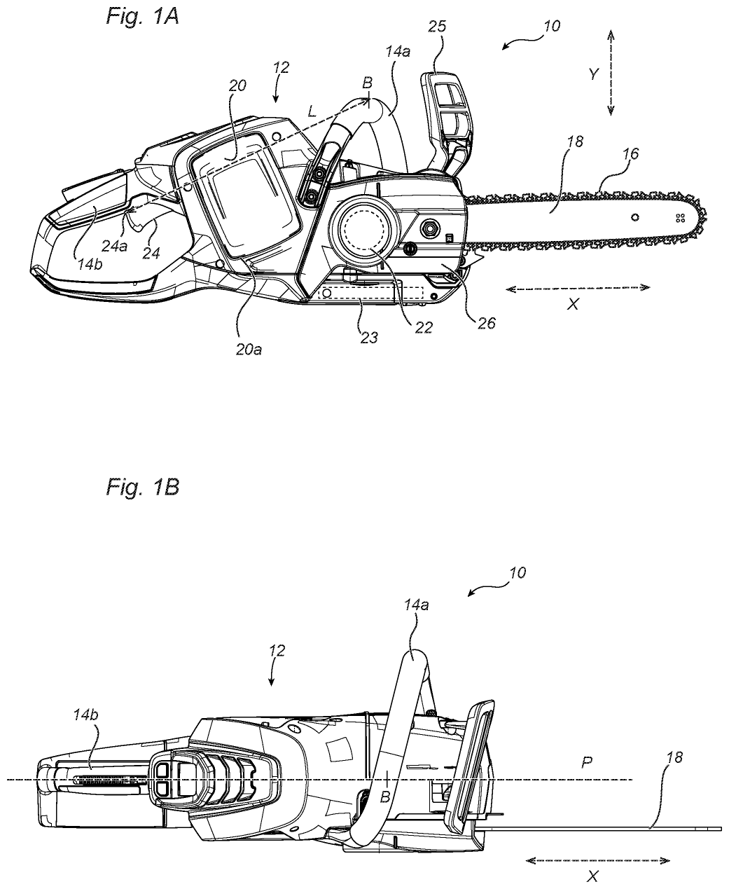

FIG. 1A illustrates a handheld battery-powered chainsaw 10. The chainsaw 10 comprises a chainsaw body 12 provided with a pair of handles 14a, 14b, by means of which an operator (not illustrated) may hold and operate the chainsaw 10. The pair of handles comprises a front handle 14a, typically for holding with the left hand, and a rear handle 14b, typically for holding with the right hand. A cutting assembly comprising a saw chain 16, and an elongate guide bar 18 guiding the saw chain 16 in an elongate loop, extends from a front end of the chainsaw body 12 along a longitudinal axis X of the chainsaw 10, which longitudinal axis X is defined by the longitudinal axis of the guide bar 18. A vertical axis Y of the chainsaw is perpendicular to the longitudinal axis X, and parallel to the extension plane of the guide bar 18. The chainsaw 10 further comprises a removable battery 20 in a battery compartment 20a, an electric motor 22 (only schematically indicated by a broken-line circle in FIG. 1A), and a finger-operated trigger 24 permitting the operator to selectively mobilize the saw chain 16 using the electric motor 22. A rearmost point 24a of the trigger 24, along the direction of the longitudinal axis X, is also indicated in FIG. 1. The chainsaw further comprises a controller 23 (only schematically indicated by a broken-line rectangle in FIG. 1A) configured to control the electric motor 22 based on input from the trigger 24. The trigger 24 extends downwards from a bottom face of the rear handle 14b, and is movable between a depressed position (not illustrated), responsive to which the electric motor 22 is operated to move the saw chain 16, and a released position (illustrated), responsive to which the saw chain 16 is stopped. A hand guard 25 in front of the front handle 14a is operatively connected to a mechanical brake arrangement for stopping the saw chain 16 in case of a kick-back. The mechanical brake arrangement is a safety feature which operates independent of the position of the trigger 24.

FIG. 1B illustrates the chainsaw 10 as seen from above. A plane P, which is parallel to the plane of the guide bar 18, comprises the rearmost point 24a of the trigger 24. The plane P intersects an uppermost, with respect to the chainsaw's 10 vertical direction Y, top point B of the front handle 14a. Referring back to FIG. 1A again, the distance between the intersection point B and the rearmost point 24a of the trigger is about 300 mm.

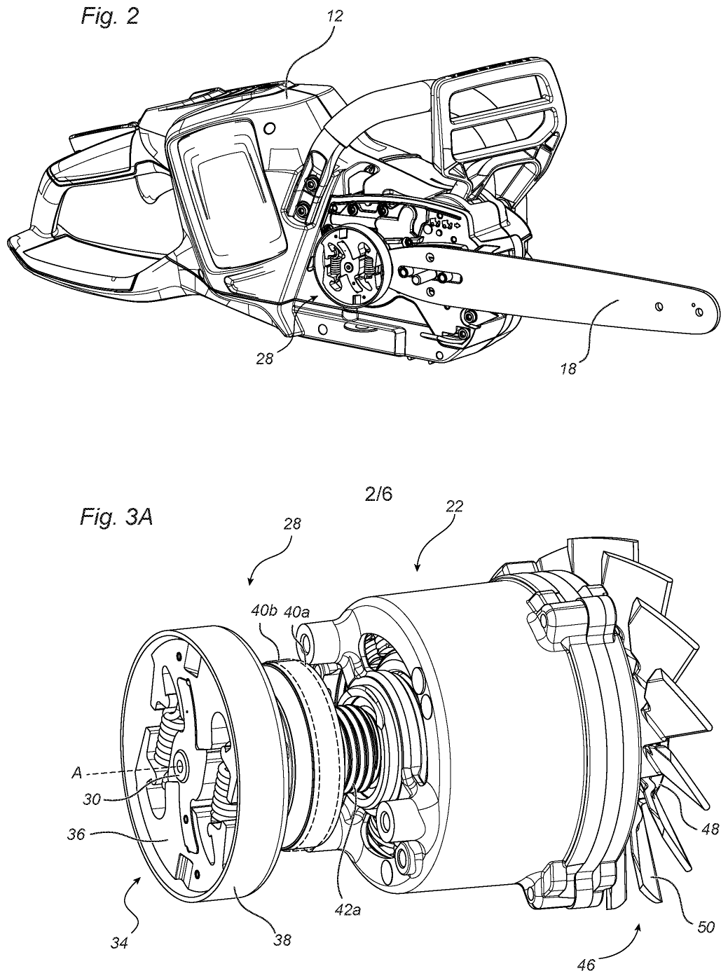

FIG. 2 illustrates the chainsaw 10 without the saw chain 16 (FIG. 1A), and with a chain sprocket cover 26 (FIG. 1A) removed to expose the attachment of the guide bar 18 to the chainsaw body 12, along with a transmission arrangement 28 transmitting rotary power from the electric motor 22 (FIG. 1A) to the saw chain 16 (FIG. 1A).

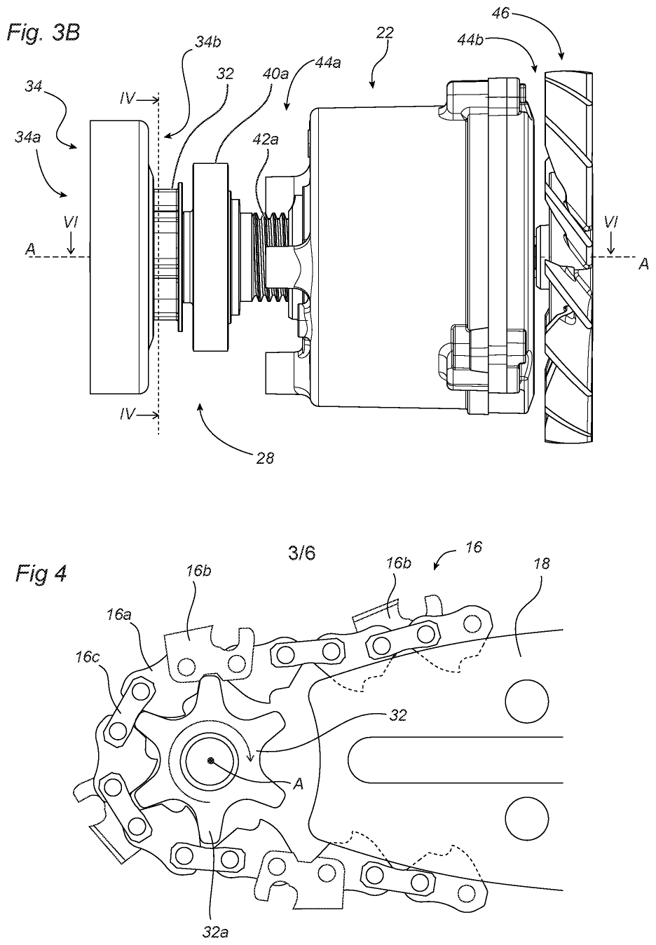

FIGS. 3A and 3B illustrate the electric motor 22 and the transmission arrangement 28 in greater detail. The transmission arrangement 28 comprises, inter alia, an output shaft 30 of the electric motor 22 which is configured to rotate about a motor rotation axis A, a saw chain sprocket 32 (FIG. 3B), and a slip clutch, in the illustrated example in the embodiment of a centrifugal clutch 34. The centrifugal clutch 34 comprises a drive member 36, which rotates with and receives rotary power from the electric motor 22 via the output shaft 30, and a driven member 38 which rotates with and transmits rotary power to the saw chain sprocket 32. As may be apparent in FIG. 3B, the drive member 36, the driven member 38, and the saw chain sprocket 32 are all configured to rotate concentrically about the motor rotation axis A. As may be apparent from the configuration of the transmission arrangement 28, the transmission arrangement 28 provides a transmission ratio of 1:1 between the electric motor 22 and the saw chain sprocket 32.

The transmission arrangement 28 further comprises a brake drum 40 configured to cooperate with a brake band 40b operated by the hand guard 25, and a worm screw 42a of a worm drive for driving a saw chain oil pump (not illustrated). In the view of FIG. 3A, the brake band 40b is only highly schematically indicated in broken lines. Both the worm screw 42a and the brake drum 40a are rotatably fixed to the saw chain sprocket 32 to rotate with the driven member 38 of the centrifugal clutch 34. Clearly, both the worm screw 42a and the brake drum 40a are highly optional; saw chain oil, if necessary, may be pumped by any other suitable means, and the brake band 40b, if any, could just as well cooperate with the radially outer face of the driven member 38 of the centrifugal clutch 34 instead.

As illustrated in FIG. 3B, the centrifugal clutch 34 has a proximal side 34a facing the electric motor 22 and a distal side 34b facing away from the electric motor 22, and the saw chain drive sprocket 32 is rigidly connected to the driven member 38 of the centrifugal clutch 34 on the proximal side 34a of the centrifugal clutch. This arrangement positions the saw chain drive sprocket 32 comparatively close to the lateral centre of the chainsaw 10 defined by the plane P (FIG. 1B).

The transmission arrangement 28 is positioned on a first axial, with regard to the rotation axis A of the electric motor 22, side 44a (FIG. 3B) of the electric motor 22. A cooling fan 46 is rigidly connected to the output shaft 30 on a second axial side 44b (FIG. 3B) of the electric motor 22, opposite the first axial side 44a. Thereby, the cooling fan 46 is coupled to always run with the electric motor 22 and the drive member side of the centrifugal clutch 34. The cooling fan 46 is configured as an axial-flow fan, and comprises a fan rotor 48 provided with a set of vanes 50 configured to blow cooling air past the electric motor 22 to cool the same. Interior structures of the chainsaw body 12 (FIG. 1A) define a fan housing (not illustrated) shaped to direct a flow of air onto the electric motor 22, the controller 23, and/or the battery 20. The cooling fan 46 is preferably made of a lightweight material such as plastic.

FIG. 4 schematically illustrates the saw chain sprocket 32, a short section of the saw chain 16, and a proximal end of the guide bar 18, in the section indicated by the line IV-IV of FIG. 3B. The saw chain sprocket 32 is rotated by the motor 22 (FIG. 1A) via the transmission arrangement 28 (FIGS. 3A and 3B), and drivingly engages with the saw chain 16 to move the saw chain 16 along the guide bar 18. As known per se, the saw chain 16 comprises drive links 16a meshing with drive teeth 32a of the saw chain sprocket 32, cutter links 16b, and tie straps 16c holding the drive links 16a together.

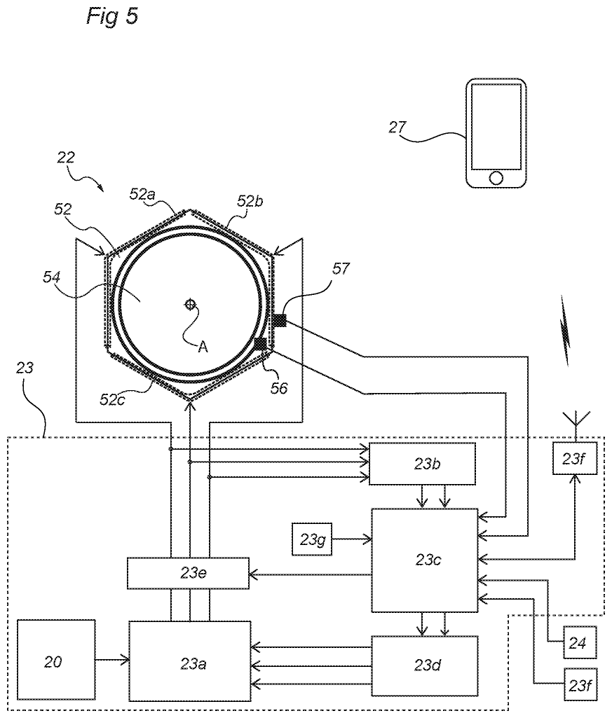

FIG. 5 schematically illustrates functional elements of the electric motor 22 and functional blocks of the controller 23 for controlling the electric motor 22. The electric motor 22 comprises a stator 52 and, radially inside the stator 52, a rotor 54 concentric with the stator 52. Alternatively, the electric motor may be of a different type, such as an outrunner (not illustrated). In the illustrated example, the electric motor 22 is a brushless DC, BLDC, motor or permanent magnet synchronous motor, PMSM, having a permanent-magnet rotor. The stator 52 may typically be a multi-phase stator, usually with three-phase windings 52a, 52b, 52c. The windings 52a-c are controlled by an inverter 23a using a field-oriented control, FOC, scheme. The inverter 23a receives power from the battery 20, and feeds power to the motor windings 52a-c according to a pulse-width modulation scheme. A step-up converter may be included in the inverter 23a to increase the voltage applied to the windings 52a-c. To employ FOC, the respective currents applied to the windings 52a-c may be measured and a converter may convert those currents by means of a Clarke/Park conversion unit 23b into direct and quadrature currents, relating to the currents parallel (direct) and perpendicular (quadrature), respectively, to the instantaneous magnetic field of the rotor 54. Those converted currents are fed to control logic 23c, and a sensor output from an optional angular position sensor 56 estimating the orientation of the rotor 54 may be fed to the control logic 23c as well. The control logic 23c generally performs a control operation, such as based on a PI (proportional, integrating) control scheme, in order to minimize the parallel current component, which does not contribute to rotor torque, and to obtain a desired perpendicular component, that does generate torque, based on an input desired torque value derived based on input from the trigger 24 (FIG. 1A). The control logic 23c in this way produces direct and quadrature voltages that are converted, using an inverse Clarke/Park and space vector modulation, SVM, modulation unit 23d, into desired inverter duty cycle values for control of the inverter to create corresponding winding voltages. The controller 23 thereby enables an accurate control of the output torque of the electric motor 22 independently of the rotational speed of the electric motor 22. The controller 23 may be configured to enable the electric motor to provide a maximum torque Tm, at the output shaft 30 (FIG. 3A), of e.g. between 2 Nm and 4.5 Nm at a rotational speed of about 4000-7000 rpm. Moreover, the controller 23 may be configured to enable the electric motor 22 to provide an exemplary maximum output power E, at the output shaft 30, of between 1.8 KW and 4.5 KW. A temperature sensor 57 communicates a temperature of the electric motor 22 to the controller 23, and thereby enables the controller 23 to detect whether the electric motor 22 runs a risk of overheating. Also the controller 23 comprises a respective temperature sensor 23g, which enables detection of overheating of the controller 23 itself. The controller 23 also comprises an induction brake 23e which is controlled by the control logic 23c to selectively apply a braking force to the motor rotor, for example when the trigger 24 is released by the operator. The induction brake 23e may apply a braking force to the rotor 54 by e.g. reversing the polarity of the magnetic fields generated by the stator coils 52a-c, or by short-circuiting the electric motor windings 52a-c. The controller 23 further comprises a wireless connection interface 23f for communicating with an external user interface 27, such as a smart phone. Thereby, the controller 23 may receive settings and/or commands from an operator (not illustrated) via the external user interface, and/or send alerts to the operator via the external user interface 27. Clearly, a user interface may also be provided directly on the chainsaw body 12.

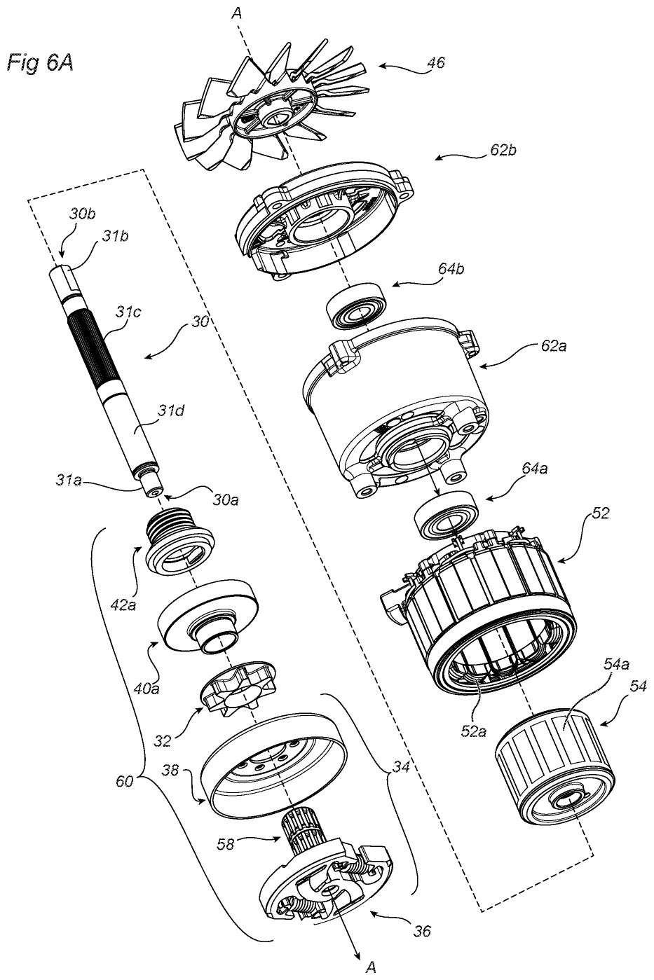

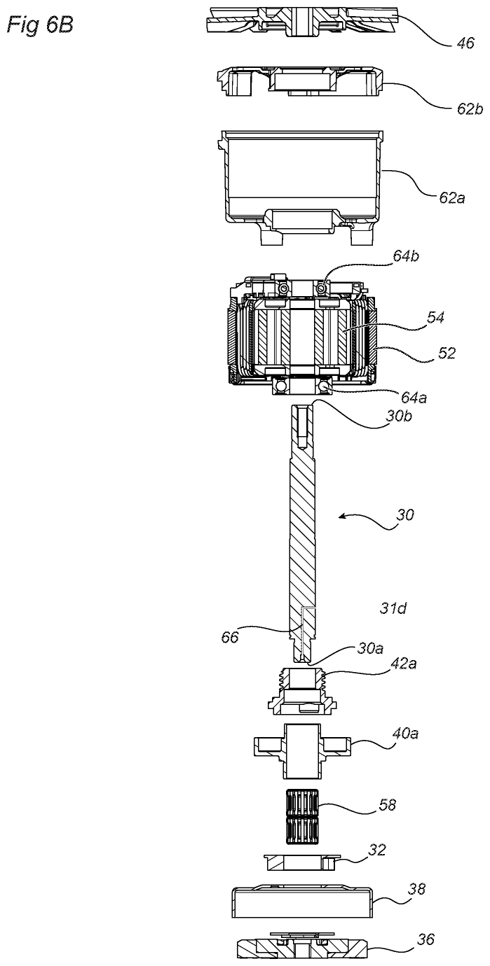

FIG. 6A is an exploded view in perspective of the electric motor 22, the fan 46, and the transmission arrangement 28, whereas FIG. 6B is illustrates the same items in a section taken along the motor rotation axis A. The output shaft 30 has a first axial end 30a provided with a first-end connection interface 31a for engaging with the drive member 36 of the centrifugal clutch 34. The first-end connection interface 31a is configured as a keyed interface (not illustrated) to rotationally lock the output shaft 30 to the drive member 36; for example, the first-end connection interface 31a may be configured as a D-shaped key. The drive member 36 may be axially held in place by e.g. a screw (not illustrated) engaging with a threaded hole in the first axial end 30a of the output shaft 30. At its second axial end 30b, opposite to the first axial end 30a, the output shaft 30 has a second-end connection interface 31b for engaging with the cooling fan 46. Also the second-end connection interface 31b is configured as a keyed interface to rotationally lock the output shaft 30 to the cooling fan 46. The cooling fan 46 may be axially held in place by e.g. a screw (not illustrated) engaging with a threaded hole in the second axial end 30b of the output shaft 30. Adjacent to the second-end connection interface 31b, the output shaft 30 has an intermediate connection interface 31c for engaging with the rotor 54. Also the intermediate connection interface 31c is configured as a keyed interface, to rotationally lock the output shaft 30 to the rotor 54; in the illustrated example, the keyed interface is defined by splines. Between the intermediate connection interface 31c and the first-end connection interface 31a, the output shaft 30 has a circular-cylindrical section 31d configured to define a bearing surface, to radially support a bearing 58 configured as e.g. a needle roller bearing. Even though illustrated as separate components for reasons of clarity, the saw chain sprocket 32 may be welded to the driven member 38 of the clutch 34. When in the assembled state, the worm screw 42a, clutch drum 40 and saw chain sprocket 32 are partly inserted axially into each other in a manner apparent from their respective shapes illustrated in the view of FIG. 6B, and keyed to each other in a rotationally interlocking manner. Thereby, the worm screw 42a, the clutch drum 40, the saw chain sprocket 32, and the driven member 38 of the centrifugal clutch 34 define a rotationally rigid unit 60 which is radially supported on the bearing 58 in a manner enabling rotation in relation to the output shaft 30.

When in the assembled state, the stator 52 is housed in a motor housing 62a, which is covered by a housing cover 62b, and the output shaft 30 is journaled in bearings 64a, 64b arranged in the motor housing 62a and housing cover 62b, respectively. The view of FIG. 6A also clearly illustrates the permanent magnets 54a distributed about the periphery of the rotor 54, along with the windings 52a of the stator 52. As illustrated in FIG. 6B, the output shaft 30 is provided with a lubrication channel 66 between the first axial end 30a and the circular-cylindrical section 31d, to enable lubrication of the bearing 58.

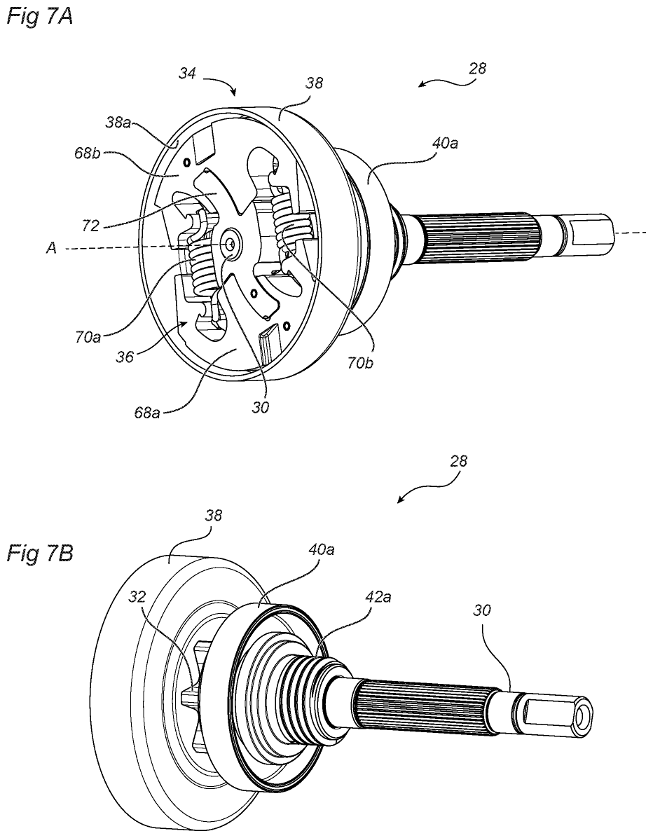

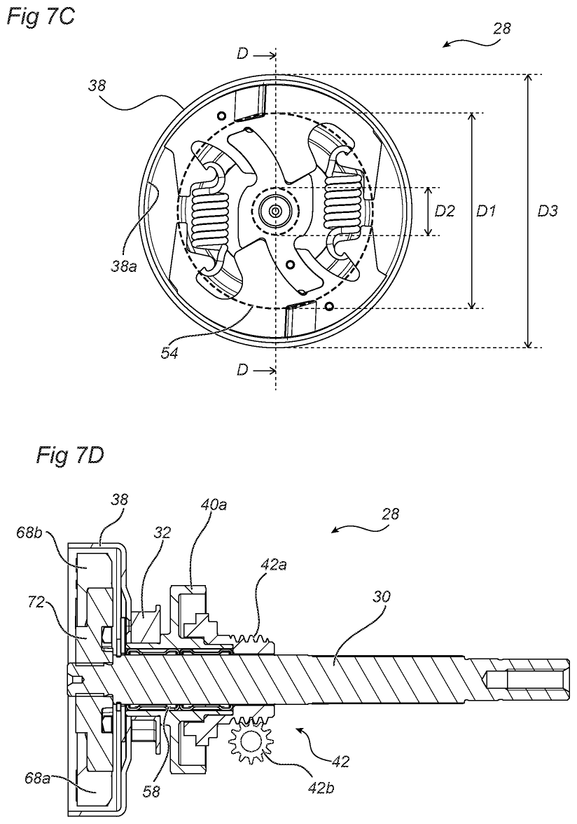

FIGS. 7A-7D illustrate the transmission arrangement 28 in greater detail. The driven member 38 of the centrifugal clutch 34 is configured as a clutch drum having a circular-cylindrical inner clutch engagement face 38a. It will be appreciated that for a centrifugal clutch, also other shapes of the clutch engagement face 38a, for example frustoconical, may be suitable.

The drive member 36 comprises a pair of friction shoes 68a, 68b held together by a pair of coil springs 70a, 70b. The friction shoes 68a, 68b are axially held in place by a friction shoe guide 72, so as to be guidedly movable in a radial direction with regard to the rotation axis A. The friction shoe guide 72 is attached to the output shaft 30 in a rotationally fixed manner. Responsive to rotation of the drive member 36, the friction shoes 68a, 68b will be pressed radially outwards, against the bias of the coil springs, by the centrifugal effect on the mass of the friction shoes 68a, 68b, in a radial engagement direction towards the clutch engagement face 38a of the clutch drum 38. Thereby, the centrifugal clutch 34 is inertia actuated, wherein the inertia of the friction shoes 68a, 68b actuates the centrifugal clutch 34 in response to a change in rotational speed.

The engagement face 38a of the clutch drum 38 has a diameter of about 70 mm. Each of the friction shoes 68a, 68b has a respective weight of about 40 g, each of the springs coil springs 70a, 70b has a respective spring constant of about 40 N/m. Thereby, the centrifugal clutch 34 is capable of transferring a torque, at the slip limit speed, of about 2 Nm.

Clearly, even though two friction shoes 68a, 68b and two coil springs 70a, 70b are illustrated in the example, also other numbers of friction shoes and springs may be used. Moreover, also other resilient elements than coil springs may be used for biasing the friction shoes 68a, 68b radially inwards. In fact, for the purpose of the present disclosure, the coil springs 70a, 70b or any other resilient elements biasing the friction shoes 78a, 78b radially inwards may be optional, because the coil springs 70a, 70b are not necessary for enabling the clutch to move between a lock-up state and a slip-enabling engaged state. The centrifugal clutch 34 operates as a slip clutch, i.e. in some situations, it enables a slip between the drive member 36 and the driven member 38. Thanks to the ability to slip, the electric motor 22 may continue its operation even if the saw chain 16 (FIG. 1A) gets stuck. This provides several benefits, as elucidated herein.

Now with reference to FIGS. 7C, the rotor 52 (schematically illustrated by a broken-line circle) has an outer rotor diameter D1, and the output shaft 30 has, at the axial position of the bearing 58, a shaft diameter D2. When combined with a slip clutch 34, an exemplary suitable ratio D1/D2 between the rotor diameter D1 and the shaft diameter D2 is between 2.5 and 4.8; in the illustrated example, it is about 4. The engagement face 38a of the clutch drum 38 has a clutch engagement face diameter D3, and an exemplary suitable ratio D1/D3 between the rotor diameter D1 and the clutch engagement face diameter D3 is between 0.50 and 1.2; in the illustrated example, it is about 0.75. The illustrated output shaft 30 has a diameter D2, at the axial position of the bearing 58, of about 12 mm. As may be apparent from e.g. FIG. 3B, the cooling fan 46 has an outer diameter exceeding the diameter of the motor housing 62a, which improves the flow of cooling air to the centrifugal clutch 34.

The section of FIG. 7D illustrates, inter alia, the worm drive 42, and the meshing engagement between the worm screw 42a and a worm wheel 42b driven by the worm screw 42a.

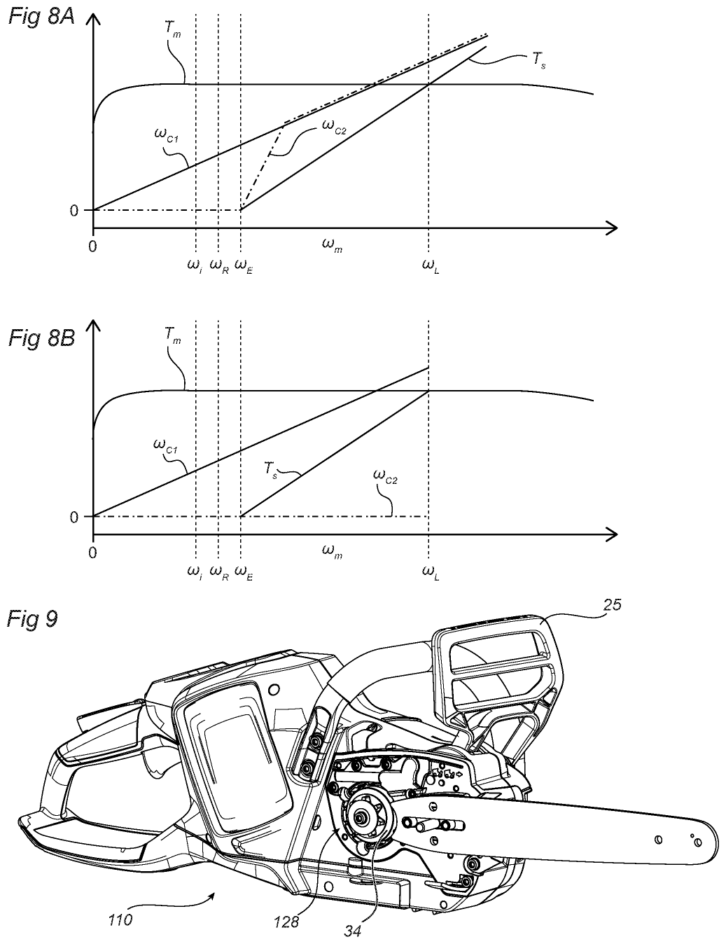

The schematic diagrams of FIGS. 8A and 8B illustrate an exemplary general behaviour of the centrifugal clutch 34 (FIG. 3A) as a function of the rotational speed ωₘ of the electric motor 22 (FIG. 3A). The rotational speed ω_{C1} of the drive member 36 follows the rotational speed ωₘ of the electric motor 22, whereas the rotational speed ω_{C2} of the driven member 38 depends on the state of the clutch 34 (FIG. 3A) and the load on the saw chain 16 (FIG. 1A). When the electric motor 22 starts, and at low rotational speeds, the centrifugal clutch 34 is in a disengaged state, i.e. the friction shoes 68a, 68b run freely without engaging with the clutch drum 38. When reaching an engagement speed ω_{E}, the friction shoes 68a, 68b (FIG. 7A) start to engage with, and slip against, the clutch engagement face 38a (FIG. 7A) of the clutch drum 38. As the speed ω_{C1} increases, the slip torque Tₛ of the centrifugal clutch 34, i.e. the torque required to make the drive member 36 slip in relation to the driven member 38, also increases.

Here, two different scenarios may be considered. In both scenarios, it is assumed that the electric motor is operated at its maximum torque Tₘ suitable for extended operation. In the first scenario, illustrated in FIG. 8A, the saw chain 16 (FIG. 1A) is free to run along the guide bar 18 (FIG. 1A), and the speed ω_{C2} of the driven member 38 will soon reach the speed ω_{C1} of the drive member 36, i.e. cease slipping.

In the second scenario, illustrated in FIG. 8B, the saw chain 16 (FIG. 1A) may be e.g. pinched in a kerf, or otherwise prevented from running along the guide bar 18 (FIG. 1A). In this scenario, the speed ω_{C2} of the driven member 38 will remain zero as long as the torque required to move the saw chain 16 exceeds the torque Tₘ of the electric motor 22. The rotational speed ω_{C1} of the drive member 36, as well as the rotational speed ωₘ of the electric motor 22, will be unable to reach any higher than a slip limit speed ω_{L} at which the slip torque Tₛ of the centrifugal clutch 34 equals the motor torque Tₘ.

Then consider going from the first, unloaded scenario to the second, loaded scenario: If the electric motor 22 is operated at a rotational speed ωₘ above the slip limit speed ω_{L}, and the saw chain 16 is exposed to a gradually increasing load which increases to exceed the motor torque Tₘ, the drive and driven members 36, 38 will remain locked to each other and their respective rotational speeds ω_{C1}, ω_{C2} will follow each other down to the slip limit speed ω_{L}, at which speed the driven member 38 stops abruptly and completely, whereas the drive member 36 remains at the slip limit speed ω_{L}.

Exemplary values on the engagement speed we and the slip limit speed WL may be, e.g., ω_{E}=about 5000 rpm and ω_{L}=about 6500 rpm. For the sake of completeness, due to frictional hysteresis of the clutch slip, the slip limit speed ω_{L} may differ somewhat depending on whether the slip limit is approached from a higher rotational speed or a lower rotational speed ω_{C1} of the driven member 36; for the sake of simplicity, this effect is disregarded herein.

In the rotational speed range of the electric motor 22 from 0 to ω_{E}, the centrifugal clutch is in a disengaged state, and the electric motor 22 is operated without setting the saw chain 16 in motion. The disengaged state enables the use of the electric motor 22 for various purposes without mobilizing the saw chain 16. For example, the electric motor 22 can be operated, either by the operator via the trigger 24 (FIG. 1A) or automatically by the controller 23 (FIG. 1A), at a speed below the engagement speed We in order to cool the engine after performing a tough cut.

In the rotational speed range of the electric motor 22 from ω_{E} to ω_{L}, the centrifugal clutch is in a slip-enabling state, in which an excessive load causes or increases slip of the centrifugal clutch 34. Expressed differently, when in the slip-enabling state, the centrifugal clutch 34 may also assume a slip state, i.e. start slipping. Also the slip-enabled state enables new features and functions of the electric motor 22. For example, when the operator presses the saw chain 16 too hard onto the material to be cut, the slip generates an audible cue which may alert the operator of the slip state, such that the operator may reduce the pressure.

In the rotational speed range of the electric motor 22 above ω_{L}, the centrifugal clutch 34 is in a lock-up state, in which an excessive load results in a decrease of the speed ωₘ of the electric motor 22 without slipping.

The states of the centrifugal clutch enable various control methods, which may be implemented in the control logic 23c of the controller 23. The control logic 23c, which may be implemented in a microcontroller, comprises memory and a processor for carrying out the various control methods. The controller 23 may also be configured to automatically detect a slip state, i.e. a state of actual or at least suspected slipping of the clutch 34. This may be done, for instance, by detecting operation at the slip limit speed ω_{L} for a time period exceeding a limit time, by detecting that the electric motor 22, when attempting to reach a set speed ωₛ, is unable to exceed the slip limit speed ω_{L}, or by comparing the motor speed ωₘ to the rotational speed ω_{C2} of the driven member 38 as received from a separate rotation sensor (not illustrated) detecting ω_{C2} at the driven member 38. For example, the controller 23 (FIG. 5) may be configured to release the induction brake 23e (FIG. 5) when the rotational speed ωₘ of the electric motor 22 falls below a limit speed, such as the engagement speed We or a separately defined an electric brake release speed ω_{R}.

FIG. 9 illustrates a handheld, battery-powered chainsaw 110 according to a second embodiment. The chainsaw 110, which is again illustrated with its chain sprocket cover 26 (FIG. 1A) removed, is identical to the chainsaw 10 of the first embodiment (FIG. 1A) except in that the chainsaw 110 of FIG. 9 comprises a transmission arrangement 128 according to a second embodiment, which replaces the transmission arrangement 28 described with reference to the chainsaw 10 of the first embodiment. Also the transmission arrangement 128 of FIG. 9 comprises a centrifugal clutch 34 of slip type.

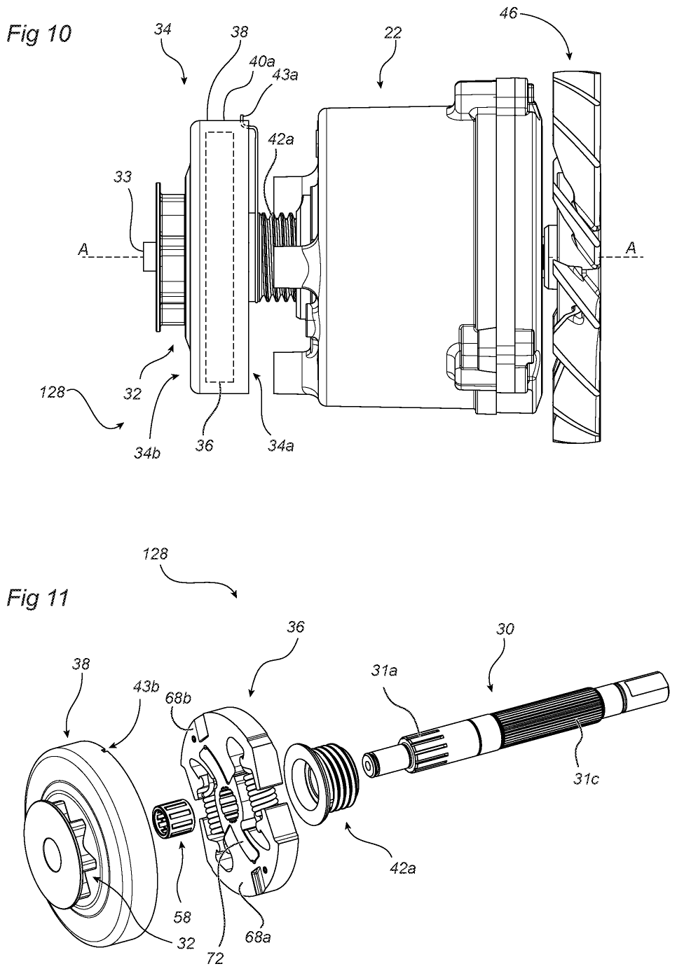

FIG. 10 illustrates, in a view corresponding to that of FIG. 3B, the electric motor 22 and the transmission arrangement 128 of FIG. 9 in greater detail, whereas the exploded view of FIG. 11 illustrates the transmission arrangement 128 of FIG. 10 in even greater detail. The transmission arrangement 128 of FIG. 10 is not provided with a separate brake drum 40 (FIG. 3A). Instead, the clutch drum 38 also operates as a brake drum 40a, and the brake band (not illustrated) operated by the hand guard 25 (FIG. 9) engages with the outer mantle face of the clutch drum 38. Unlike the embodiment illustrated in e.g. FIG. 3B, the saw chain drive sprocket 32 is rigidly connected to the clutch drum 38 on the distal side 34b of the centrifugal clutch 34. The clutch drum 38 is instead open towards the proximal side 34a of the clutch 34 to receive the drive member 36 from the proximal side 34a. Similar to the first embodiment 28, the drive member 36 comprises a set of friction shoes 68a, 68b and a friction shoe guide 72 driven by the output shaft 30 of the motor 22, for example via splines 31a. In the view of FIG. 10, the position of the drive member 36 is schematically indicated by broken lines. The clutch drum 38 and the worm screw 42a for driving the saw chain oil pump are mounted rotationally journaled on the output shaft 30, so as to enable rotation independent of the drive member 36. A metal wire spring 43a (FIG. 10), attached to the worm screw 42a, engages with a notch 43b (FIG. 11) in the clutch drum 38, such that the worm screw 42a rotates with the clutch drum 38. The saw chain drive sprocket 32 and the clutch drum 38 are axially held to the output shaft 30 of the motor 22 by the head 33 (FIG. 10) of a screw, which engages with the output shaft 30.

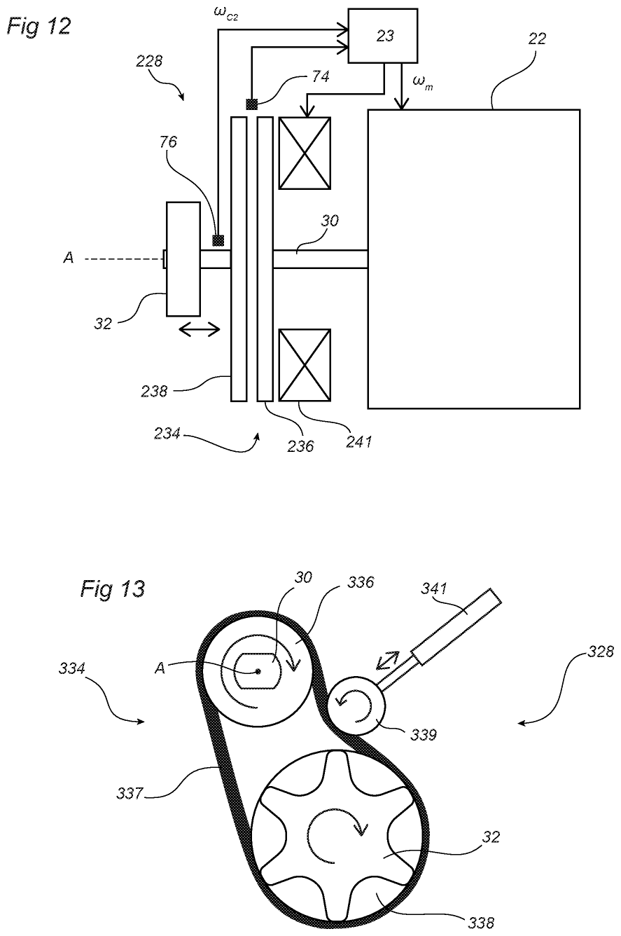

FIG. 12 schematically illustrates the electric motor 22 and a transmission arrangement 228 according to a third embodiment. The transmission arrangement 228 may replace the transmission arrangements 28, 128, described hereinabove, in the chainsaw 10 (FIG. 1A). The transmission arrangement 228 according to the third embodiment comprises an electromagnetic clutch 234, the rotation axis of which is concentric with the rotation axis A of the electric motor 22. The electromagnetic clutch 234 comprises a drive member configured as a clutch rotor plate 236, a driven member configured as an armature plate 238, and a field coil 241 controlled by the control logic 23c (FIG. 5) of the controller 23 (FIG. 1A). The controller 23 is configured to selectably actuate the clutch 234 by generating a current in the field coil 241, thereby magnetizing the clutch rotor plate 236. The magnetic field generated by the field coil 241 attracts the armature plate 238 along the motor rotation axis A, and thereby brings the armature 238 into contact with the rotor plate 236. Depending on the current generated in the field coil 241, the clutch 234 may be in a disengaged state, in which the clutch rotor plate 236 is free to rotate without mobilizing the saw chain 16 (FIG. 1A), and an engaged state, in which torque is transferred to set the saw chain 16 in motion. When in the engaged state, the clutch 234 may be in a slip-enabling state, in which the clutch rotor plate 236 may slip in relation to the armature plate 238, and a lock-up state, in which the clutch 234 is configured to drive the saw chain 16 without slipping. Thereby, the controller 23 may selectably set the clutch in anyone of the aforementioned states. Clearly, the controller's 23 control signal to the field coil 241 provides the controller 23 with a priori knowledge of whether the clutch 234 is engaged or disengaged. Alternatively, a clutch state sensor 74 may directly detect the state of the clutch 234, for example by detecting the axial position of the armature plate 238, and thereby enable the controller to detect whether the clutch is engaged or disengaged. A rotation sensor 76 detects the rotational speed ω_{C2} of the armature plate 238. By comparing the rotational speed ω_{C2} of the armature plate 238 to the rotational speed ωₘ of the electric motor 22, the controller 23 can determine whether the clutch is in a slip state; thereby, the rotation sensor 76 operates as a slip detector. According to some embodiments, the controller may be configured to transit the clutch 234 between the clutch states based on the rotational speed ωₘ of the electric motor 22 (FIG. 1A). Thereby, the electromagnetic clutch 234 of FIG. 12 may be set to operate in a manner similar to the centrifugal clutch 34 of e.g. FIG. 6A. The engagement speed we and the slip limit speed ω_{L} for transiting between the clutch states may optionally be set by the operator via the user interface 27. In fact, different limit speeds may be set depending on whether the speed Wm increases or decreases. For example, the controller may be configured to transit the clutch 234 from the disengaged state to the engaged state at an engagement speed ω_{E}, and to transit the clutch 234 from the engaged state to the disengaged state at a disengagement speed ω_{D}, which may be different from the engagement speed ω_{E}. The controller 23 (FIG. 5) may further be configured to release the induction brake 23e (FIG. 5) whenever the electromagnetic clutch 234 is in the disengaged state.

FIG. 13 schematically illustrates a transmission arrangement 328 according to a fourth embodiment. The transmission arrangement 328 may replace the transmission arrangements 28, 128, 228, described hereinabove, in the chainsaw 10 (FIG. 1A). The transmission arrangement 328 according to the fourth embodiment comprises an electromechanical clutch configured as a belt clutch 334. The belt clutch 334 comprises a drive member configured as a drive pulley 336, which is attached to the drive shaft 30 to receive rotary power from the electric motor 22 (FIG. 1A), and a driven member configured as a driven pulley 338, which is attached to the saw chain drive sprocket 32. In the illustrated embodiment, the drive member 336 and the driven member 338 may rotate about parallel rotation axes, but the rotation axes are not concentric. The drive pulley 336 and the driven pulley 338 are connected by a drive belt 337, the tension of which may be controlled by adjusting the position of an idler wheel 339. Depending on the tension in the drive belt 337, the clutch 334 may be in a disengaged state, in which the drive pulley 336 is free to rotate without mobilizing the saw chain 16 (FIG. 1A), and an engaged state, in which torque is transferred to set the saw chain 16 in motion. When in the engaged state, the clutch 334 may be in a slip-enabling state, in which the drive pulley 336 may slip in relation to the driven pulley 338, and a lock-up state, in which the clutch 334 is configured to drive the saw chain 16 (FIG. 1A) without slipping. The idler wheel 339 is moved by a clutch actuator 341 in response to control signals generated by the control logic 23c of the controller 23 (FIG. 1A). Thereby, the controller may selectably set the clutch in anyone of the aforementioned states.

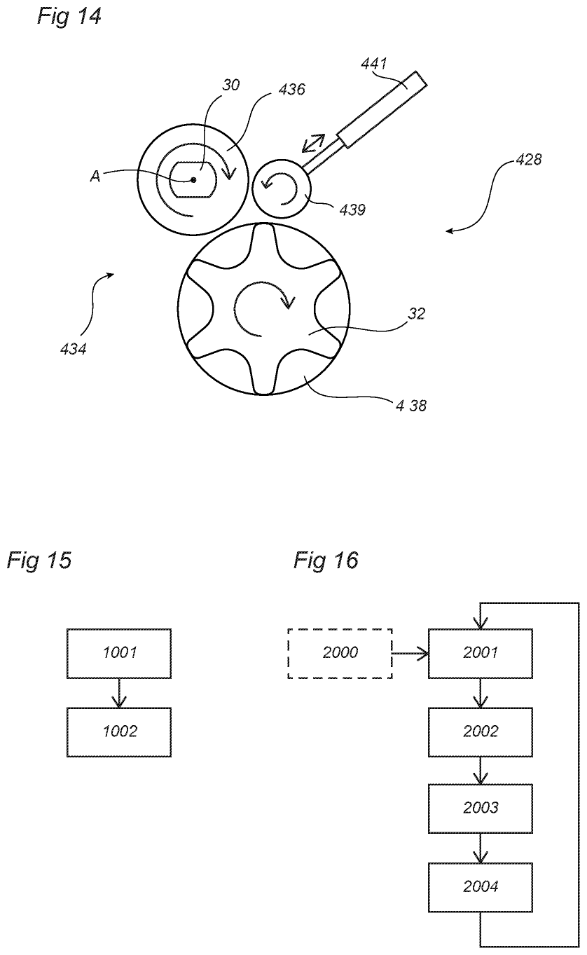

FIG. 14 schematically illustrates yet another transmission arrangement 428 according to a fifth embodiment, which may replace the transmission arrangements 28, 128, 228, 328 described hereinabove. The transmission arrangement 428 according to the fifth embodiment comprises a drive wheel 436 attached to the drive shaft 30, and a driven wheel 438 attached to the saw chain drive sprocket 32. An electromechanical clutch 434 is configured as a selectably engageable idler wheel 439 between the drive wheel 436 and the driven wheel 438. Again, the idler wheel 439 is moved by a clutch actuator 341 in response to control signals generated by the control logic 23c of the controller 23 (FIG. 1A), thereby enabling the controller 23 to set the clutch 434 in anyone of the aforementioned states.

FIG. 15 illustrates a first method of controlling the electric motor 22 to selectively drive the saw chain 16.

In a first method step 1001, the controller determines a state of the clutch 34, 234, 334, 434. The state of the clutch may be determined by e.g. determining the rotational speed of the electric motor 22, in the case of a rotational speed actuated clutch, by determining the set state of the clutch in the case of an electromagnetic or electromechanical clutch, or by detecting an actual slip state as described hereinabove.

In a second method step 1002, the controller 23, based on the determined clutch state, adjusts the torque Tₘ and/or the rotational speed of the electric motor Wm, and/or generates an alert to an operator of the chainsaw.

According to an embodiment, step 1001 may comprise, for example, determining that the clutch 34, 234, 334, 434 is in a slip state or has been in a slip state for a period of time exceeding a limit time. Step 1002 may comprise, for example, generating an alert to the operator by e.g. lighting a lamp, sounding an alarm, or operating the electric motor 22 according to a predetermined pattern by e.g. varying the rotational speed ωₘ and/or the torque Tₘ of the electric motor 22. The rotational speed ωₘ and/or the torque Tₘ of the electric motor 22 may be pulsed by a pulse frequency of e.g. an audibly or haptically perceivable frequency. In the case of a centrifugal clutch 34, pulsing the torque Tₘ near the slip limit speed ωₘ may contribute to setting a stuck saw chain back in motion.

According to another embodiment, step 1001 may again comprise, for example, determining that the clutch 34, 234, 334, 434 is in a slip state or has been in a slip state for a period of time exceeding a limit time. Step 1002 may comprise, for example, temporarily increasing the torque Tₘ of the electric motor 22 to an excess torque T+ above a maximum torque Tₘₐₓ permitted for continuous operation of the electric motor. Thereby, the temporarily increased torque T+ may enable setting a stuck saw chain 16 (FIG. 1A) in motion.

According to yet another embodiment, step 1001 may again comprise, for example, determining that the clutch 34, 234, 334, 434 is in a slip state or has been in a slip state for a period of time exceeding a limit time. Step 1002 may comprise reducing the motor torque Tₘ and/or the rotational speed ωₘ of the electric motor 22. In the case of a rotational speed actuated clutch such as the centrifugal clutch 34 (FIG. 3A), for example, the controller 23 may disregard any input from the trigger 24 (FIG. 1A), and automatically reduce the rotational speed ωₘ to below an engagement speed ω_{E} of the clutch 34. The controller may be configured to refrain from enabling any further increase of the rotational speed ωₘ above the engagement speed ω_{E} until the operator has first released the trigger 24, and thereafter pressed it again.

According to still another embodiment, step 1001 may again comprise, for example, determining that the clutch 34, 234, 334, 434 is in a slip state or has been in a slip state for a period of time exceeding a limit time. Step 1002 may comprise first, if the trigger remains fully depressed, varying the rotational speed ωₘ and/or the torque Tₘ of the electric motor 22 during a limited time, and thereafter, disregarding any input from the trigger 24 and automatically disengaging the clutch 34, 234, 334, 434, for example by reducing the rotational speed ωₘ below the engagement speed ω_{E} of the electric motor 22 in the case of a centrifugal clutch 34 (FIG. 3A).

According to yet another embodiment, step 1001 may comprise, for example, determining that the clutch 34, 234, 334, 434 is in a disengaged state. Step 1002 may comprise operating the electric motor 22 at a predetermined rotational speed suitable for operating the cooling fan 46, and/or reducing the motor torque Tₘ by reducing the current to the rotor windings 52a-c in order to cause a low power consumption while operating the fan 46.

FIG. 16 illustrates a second method of controlling the electric motor 22 to selectively drive the saw chain 16.

In step 2001, the controller detects that the trigger 24 (FIG. 1A) is in a fully released position, and operates the electric motor 22, thereby operating the fan 46 (FIG. 3A).

In step 2002, a depression of the trigger 24 is detected by the controller 23 (FIG. 5), and in response, the controller 23 engages the clutch 34, 234, 334, 434, thereby setting the saw chain 16 (FIG. 1A) in motion and operating the saw chain oil pump.

In step 2003, a full release of the trigger 24 is detected by the controller 23, and in response, the controller disengages the clutch 34, 234, 334, 434, thereby immobilizing the saw chain 16.

In step 2004, the controller maintains operation of the electric motor 22 after the full release of the trigger 24 and the disengagement of the clutch 34, 234, 334, 434, thereby maintaining operation of the fan 46.

According to an embodiment, in step 2001 and/or step 2004, the controller 23 may be configured to operate the electric motor 22 based on a further condition that a temperature reading from a temperature sensor, such as the motor temperature sensor 57 or the controller temperature sensor 23g, exceeds a limit temperature. The controller 23 may also, or alternatively, be configured to maintain operation of the electric motor 22 for a predetermined time, for example for 30 seconds, to allow the electric motor to cool off after a cut. Alternatively or additionally, the controller 23 may be configured to operate the electric motor 22 based on the state of the mechanical brake arrangement 40a, 40b (FIG. 3A), for example based on a further condition that the mechanical brake arrangement 40a, 40b is engaged.

In the case of a rotational speed actuated clutch such as the centrifugal clutch 34 (FIG. 3A), in step 2002, the controller may engage the clutch 34 by increasing the rotational speed ωₘ of the electric motor 22 above the engagement speed ω_{E} of the centrifugal clutch 34. In steps 2001 and/or 2004, the controller 23 may be configured to operate the electric motor 22 at an idle speed ωᵢ (FIG. 8A), which may be e.g. about 4000 rpm.

In an optional step 2000 preceding step 2001, the controller 23 may automatically start operation of the electric motor 22, without engaging the slip clutch, e.g. in response to the chainsaw 10 being switched on via an on/off switch (not illustrated), and/or in response to a detection that that the chainsaw 10 has been lifted, as indicated by e.g. an accelerometer (not illustrated), and/or in response to a detection that one or both handles 14a, 14b has been gripped by the operator, as indicated by e.g. capacitive sensors (not illustrated) at the handles 14a, 14b.

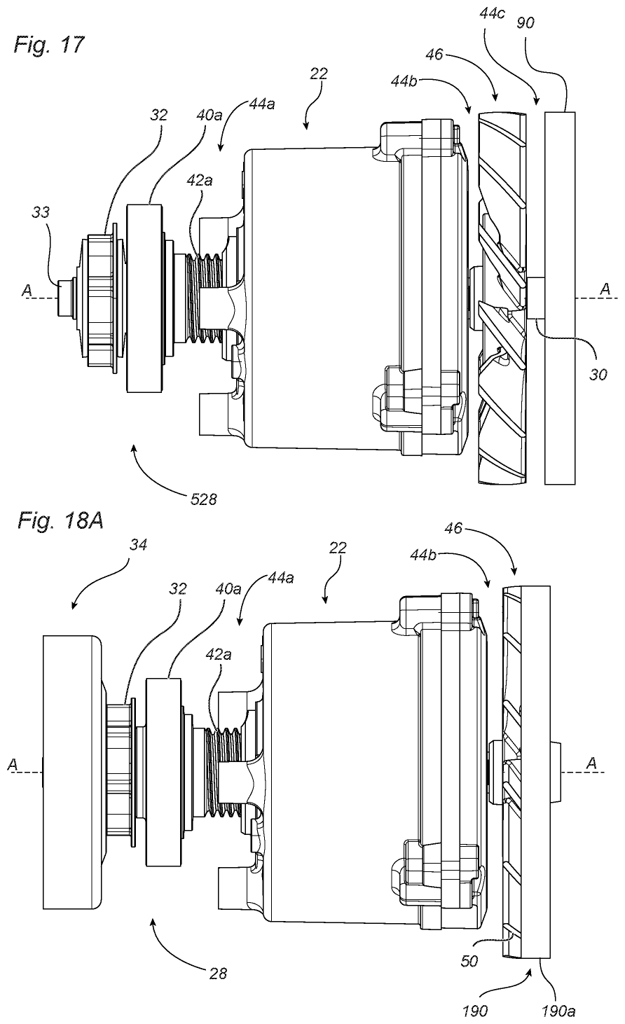

FIG. 17 schematically illustrates yet another transmission arrangement 528 according to a sixth embodiment, which may replace the transmission arrangements 28, 128, 228, 328, 428 described hereinabove in the handheld battery-powered chainsaws 10 or 110 of FIG. 1A. The transmission arrangement 528 according to the sixth embodiment differs from the transmission arrangement 128 of FIG. 11 in that it does not comprise a clutch. Instead, the brake drum 40a, the worm screw 42a, and the saw chain drive sprocket 32 are coupled to always rotate with the electric motor 22. The saw chain drive sprocket 32, the brake drum 40a, and the worm screw 42a all engage with splines of the output shaft 30 (FIG. 11), and are axially held in place by a screw 33 and a washer. Moreover, in the illustrated embodiment, the electric motor 22 also drives a flywheel 90. The flywheel 90 is coupled to rotate with the rotor 54 (FIG. 6A) of the electric motor 22 about a flywheel rotation axis, which coincides with the rotation axis A of the electric motor 22. Thereby, the flywheel 90 receives and stores angular momentum from the electric motor 22, which contributes to maintaining the speed of the saw chain 16 (FIG. 1) when engaging with the material to be cut. The flywheel 90 is attached to the output shaft 30 on a distal side 44c of the fan 46, i.e. on the side of the fan 46 facing away from the electric motor 22. An axial gap is provided between the flywheel 90 and the fan 46, which reduces any tendency of the flywheel 90 to obstruct the flow of air into the fan 46. According to an alternative embodiment (not illustrated), the flywheel 90 may be provided on the proximal side of the fan 46, i.e. on the side of the fan 46 facing the electric motor 22. Such a configuration moves the mass and moment of inertia of the flywheel 90 closer to the lateral centre of the chainsaw 10 (FIG. 1), which improves the agility of the chainsaw 10, i.e. the ease with which the operator moves the chainsaw 10 during operation. The flywheel 90 has a weight of about 125 g and an outer diameter of about 90 mm. In particular, the flywheel 90 is configured as an inertia ring of steel suspended on the output shaft 30 via spokes (not illustrated), such that the weight of the flywheel 90 is concentrated to the radially outermost, with regard to the rotation axis A, portion of the flywheel 90. The spokes also enable an axial flow of air to enter the fan 46. In the embodiment of FIG. 17, the total moment of inertia J of the rotor 54 (FIG. 6A) and all components rotated by the rotor 54, i.e. including the shaft 30, the fan 46, the brake drum 40a, the worm screw 42a, the saw chain drive sprocket 32 and the flywheel 90, is about 2.4*10⁻⁴ kgm². The flywheel 90 represents about 60% of this total moment of inertia, i.e. about 1.4*10⁻⁴ kgm². The total mass M of the rotor 54 and all components rotated by the rotor 54 is about 440 g, which results in a ratio J/M between the mass M and the moment of inertia J of about 5.5 m². A large J/M ratio indicates a high weight-efficiency of the chainsaw's 10 inertial energy storage.

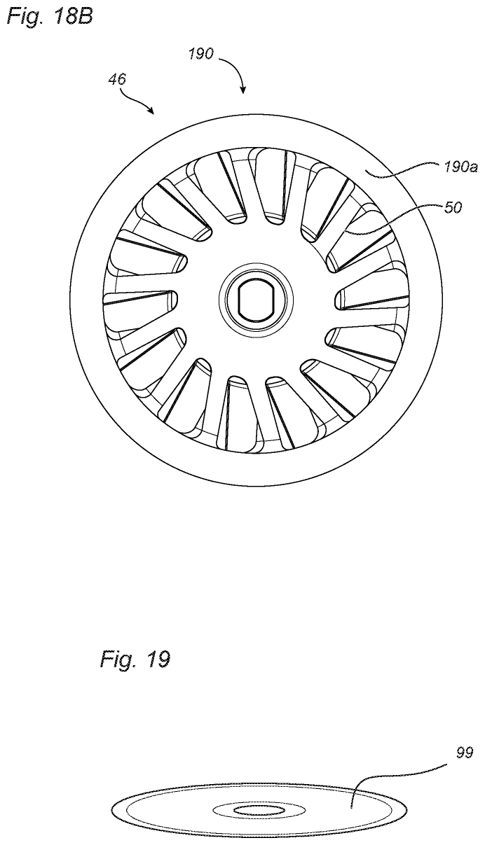

FIGS. 18A and 18B illustrate a flywheel 190 according to a second embodiment, wherein the flywheel 190 is connected to the transmission arrangement 28 of the first embodiment as illustrated in FIGS. 3A and 3B, including the clutch 34. FIG. 18B illustrates the flywheel 190 as seen along the rotation axis A of the electric motor 22. The flywheel 190 of FIGS. 18A and 18B comprises an inertia ring 190a attached directly to the vanes 50 of the fan 46. Thereby, the vanes 50 of the fan 46 also operate as spokes, holding the mass of the inertia ring 190 at a radial distance from the rotation axis A. The vanes 50 may be made of a relatively lighter material, such as aluminium or plastic, whereas the inertia ring may be made of a relatively heavier material, such as steel or copper. As is apparent from FIG. 18A, the inertia ring 190a extends to 100% of the total radius of the flywheel 190, i.e. defines the radially outermost rim of the flywheel 190. Even though FIGS. 18A and 18B illustrate a combined fan 46 and flywheel 190, clearly, in order to increase the moment of inertia of the transmission arrangement without unduly increasing the dead weight of the transmission arrangement, weight can be added also at the radially outermost portions of other rotating components of the transmission arrangement 28.

FIG. 19 illustrates a computer-readable storage medium embodied as a CD (compact disc) 99. The CD 99 has stored thereon a computer program product comprising instructions which, when the program is executed on a processor, carries out any of the methods defined hereinabove.

The invention has mainly been described above with reference to a few embodiments. However, as is readily appreciated by a person skilled in the art, other embodiments than the ones disclosed above are equally possible within the scope of the invention, as defined by the appended patent claims.

For example, the invention has been described with reference to a chainsaw of rear-handle type. However, it will be appreciated that the teachings herein are equally applicable to a chainsaw of top-handle type.

In the claims, the word “comprising” does not exclude other elements or steps, and the indefinite article “a” or “an” does not exclude a plurality.

1. A handheld battery-powered chainsaw comprising:
an electric motor; and
a transmission arrangement coupled to the electric motor, wherein the electric motor is configured to drive a saw chain via the transmission arrangement,
wherein the transmission arrangement comprises a slip clutch, comprising a drive member configured to receive rotary power from the electric motor and a driven member configured to transmit rotary power to the saw chain, wherein the slip clutch is configured to at least partly disengage the electric motor from the saw chain by enabling a slip in the engagement between the drive member and the driven member.

2. The handheld battery-powered chainsaw according to claim 1, wherein the transmission arrangement is configured to provide a transmission ratio of 1:1 between the electric motor and a saw chain sprocket meshing with the saw chain.

3. The handheld battery-powered chainsaw according to claim 1, wherein the slip clutch is configured to transfer a slip torque, while slipping, of between 2 Nm and 4.5 Nm.

4. The handheld battery-powered chainsaw according to claim 1, wherein the slip clutch is movable between an engaged state, in which the slip clutch is configured to drive the saw chain, and a disengaged state, in which the drive member can rotate freely without driving the saw chain.

5. The handheld battery-powered chainsaw according to claim 4, wherein the slip clutch is configured to transit between the engaged state and the disengaged state in response to a change in rotational speed.

6. The handheld battery-powered chainsaw according to claim 5, wherein the slip clutch is configured to transit, in response to a change in rotational speed of the drive member, between a slip-enabling state, in which the drive member is enabled to slip in relation to the driven member, and a lock-up state, in which the slip clutch is configured to drive the saw chain without slipping.

7. The handheld battery-powered chainsaw according to claim 6, wherein the slip clutch is configured to transit between the disengaged and engaged states at a predetermined clutch engagement speed, above which the slip clutch assumes the engaged state, and to transit from the slip-enabling state to the lock-up state at a predetermined slip limit speed, above which the slip clutch assumes the lock-up state, wherein the slip limit speed is at least 200 rpm higher than the engagement speed.

8. The handheld battery-powered chainsaw according to claim 1, wherein the slip clutch is inertia actuated.

9. The handheld battery-powered chainsaw according to claim 4, wherein the slip clutch is configured as a centrifugal clutch.

10. The handheld battery-powered chainsaw according to claim 9, wherein the driven member comprises a clutch drum having a diameter of between 60 mm and 90 mm, and the drive member comprises a set of two or three;
preferably two, friction shoes which are resiliently connected to each other by resilient elements, wherein each of the friction shoes has a respective weight of between 30 g and 70 g, and each of the resilient elements has a spring constant of between 35 nm/mm and 60 N/mm.

11. The handheld battery-powered chainsaw according to any of the preceding claims claim 1, wherein the slip clutch has a proximal side facing the electric motor and a distal side facing away from the electric motor, wherein a saw chain drive sprocket is connected to the driven member of the slip clutch on the distal side of the slip clutch.

12. The handheld battery-powered chainsaw according to claim 1, wherein the slip clutch has a proximal side facing the electric motor and a distal side facing away from the electric motor, wherein a saw chain drive sprocket is connected to the driven member of the slip clutch on the proximal side of the slip clutch.

13. The handheld battery-powered chainsaw according to claim 1, wherein the electric motor has a rotor configured to be rotated by a stator, the rotor having an outer rotor diameter, and
an output shaft drivingly connected to the drive member of the slip clutch, the output shaft having a shaft diameter, wherein a ratio between the rotor diameter and the shaft diameter is between 2.5 and 4.8.

14. (canceled)

15. The handheld battery-powered chainsaw according to claim 1, further comprising a mechanical brake arrangement movable between a braking position, in which the mechanical brake arrangement is configured to engage with the transmission arrangement to brake the rotation of the driven member, and a released position, in which the driven member is free to rotate.

16.-22. (canceled)

23. The handheld battery-powered chainsaw according to claim 1, further comprising a cooling fan coupled to always run with a drive member side of the slip clutch.

24. The handheld battery-powered chainsaw according to claim 23, wherein the slip clutch is positioned on a first axial side of electric motor, and the cooling fan is positioned on a second axial side of the motor, opposite to said first axial side.

25.-52. (canceled)

53. A method of controlling an electric motor to selectively drive a saw chain in a chainsaw comprising a clutch, the method comprising:
determining a state of the clutch; and
based on the determined clutch state, adjusting a torque or rotational speed of the electric motor, and/or generating an alert to an operator of the chainsaw.

54. The method according to claim 53, wherein determining a state of the clutch comprises determining a present rotational speed (ωₘ; ω_{C1}; ω_{C2}).

55. The method according to claim 53, wherein said clutch state is a slip state, and adjusting a torque or rotational speed of the electric motor comprises lowering the rotational speed below the clutch engagement speed, and/or reducing the torque of the electric motor.

56. The method according to claim 53, wherein said clutch state is a slip state, wherein adjusting the torque or the rotational speed of the electric motor comprises increasing the torque of the electric motor.

57.-61. (canceled)
